(19) United States
(12) Patent Application Publication
(10) Pub. No.: US 2021/0187508 A1
(43) Pub. Date: Jun. 24, 2021

(54) SYSTEMS AND METHODS FOR PARTICULATE ENCAPSULATION IN MICRODROPLETS

(71) Applicant: 1 CellBio ,Inc., Watertown, MA (US)

(72) Inventors: Steven Scherr, Brookline, MA (US); Colin J.H. Brenan, Marblehead, MA (US); Michael J. Brenan, Marblehead, MA (US); Marcel Reichen, Wadenswil (CH)

(21) Appl. No.: 16/756,222

(22) PCT Filed: Oct. 16, 2018
(86) PCT No.: PCT/EP2018/078309

§ 371 Date: Apr. 15, 2020

Related U.S. Application Data
(60) Provisional application No. 62/572,956, filed on Oct. 16, 2017.

(51) Int. Cl. B01L 3/00

(52) U.S. Cl. CPC B01L 3/502776; B01L 2200/0647; B01L 2200/0636

(57) ABSTRACT

The present invention generally relates to microfluidic droplets and, in particular, to multiple emulsion microfluidic droplets. Provided are methods and a device of ordering, sorting and/or focusing particles, the method comprising leading the particles through a microfluidic channel comprising a channel height (H) in the range of (1.8) D to (1.2) D and a channel width (W) in the range of (1.33) D to 1 D, wherein D is the particle diameter.

### FIELD OF THE INVENTION

The present invention generally relates to the methods and systems for encapsulation of particles in microfluidic droplets that overcome the limitations of random loading and other related techniques and resulting in a method and system for efficiently encapsulating a controllable number of particles in each droplet.

### BACKGROUND

Loading microfluidic drops with discrete objects, such as particles and cells, is often necessary when performing chemical and biological assays in microfluidic devices. The drops can serve as nanoliter to picoliter vessels within which individual reactions can be performed and with microfluidic devices, the drops can be formed, merged and sorted at high rates (up to several kilohertz). This combination of speed, containment and small volumes is very useful for many applications, such as screening libraries of unknown chemical compounds or cells to identify a subset of useful chemical compounds or cells, evolving cells and enzymes, and analyzing genetic material.

All such applications require the encapsulation of cells, beads, other particles and other discrete reagents in the drops. However, current techniques for encapsulating particulates in microdroplets are very inefficient, with the number of particulates encapsulated per drop highly variable from zero, 1 or >2 particles. In one approach, the particulates in a liquid suspension with an average concentration of λ are encapsulated into drops in a microfluidic system and since the arrival of particulates in the microfluidic system is not predictable and are independent events, the probability of zero, one or more than two particles encapsulated in any given drop follows Poisson statistics and the probability of k particles per drop is

P(k)=λ^{k}e^{-λ}/k!.

Assuming an average of 0.5 particles per nanoliter drop (=500,000 cells/ml and λ=0.5), the probability of having zero particles per drop=60% (P(0)=0.6); 1 particle per drop=32.5% (P(1)=0.325) and >2 particles per drop=0.75% (P(>2)=0.075). This encapsulation process is therefore inefficient where approximately a third of the drops have at least one particle and approximately two-thirds of the drops do not. In some applications it is preferred to have only one particle in a drop, for example one cell in a drop to detect a unique secreted product (e.g. antibody, enzyme) from that cell. Decreasing further the average particle per drop exacerbates this difference and inefficiency by further increasing the number of empty drops, decreasing the number of drops with one particle and decreasing further still the number of drops with two or more particles. This is not desirable if the particle is for uniquely barcoding or labeling with another molecule (e.g. fluorophore) the molecules (e.g. nucleic acid, proteins) in a cell co-encapsulated in the drop with a particle with multiple copies of a unique barcode or molecular label. A molecular label is a molecule that is attached uniquely to the oligonucleotides, proteins, lipids or carbohydrate molecules of a cell that is used as a unique identifier of the cell and its contents. Typically, the molecular label could be a unique oligonucleotide sequence that could be measured or analyzed using a variety of standard nucleic acid measurement methods like FISH, PCR, real-time PCR and/or sequencing. Another typical molecular label could be one that is optically active like a fluorescent molecule, a is Raman-active molecule, a phosphorescent molecule or an absorptive molecule whose optical emission, scattering or absorption uniquely identifies and measures the labeled molecules from a single cell. These molecules could be intrinsic to the cell or ones secreted by the cell into the surrounding environment. In the event of two or more particles with different barcodes or molecular labels co-encapsulated in the same drop with one cell, the molecules will be barcoded with two different unique barcodes or molecular labels which will make it difficult to distinguish if those barcoded or labeled molecules originated from the same cell. Conversely, if two or more cells are encapsulated in the same drop with a single barcoded or labeled particle, the same barcode or label will encode molecules from two different cells thereby causing the number of molecules to be over represented in an analysis that uses the barcode as a unique label of molecules from a specific cell. According to Poisson statistics, decreasing the density of suspended cells (A) increases the number of empty drops, decreases the number of drops encapsulating one cell with one particulate in the drop and greatly diminishes the number of drops with two or more cells encapsulated with one particle. This solution is less desirable since the number of drops needed to encapsulate one cell with one particle greatly increases and negates the intrinsic speed and efficiency of microfluidics.

The inherent inefficiency of co-encapsulating different particles in a drop based on a method resulting in a Poisson statistical distribution of unique particles in a population of drops has stimulated the development of new methods overcoming this limitation and provide an encapsulation efficiency greater than what is possible with a Poisson statistical process. Abate et al. (Abate et al., Lab Chip, 2009, 9:2628-2631) describe one approach with compliant gel particles that are deformable and are packed at near 100% volume fraction without clogging in a channel height and width specified to be less than the diameter of the gel particle. This restriction forms a monolayer of particles in a regular, close-packed configuration which can fill a microchannel with a width equal to or less than the particle diameter and a height less than the particle diameter. Making the rate of drop formation equal to the rate of gel particles exiting the defined microchannel into the drop forming junction enables the encapsulation of gel particles in drops at efficiencies between 80-98%. In other words, out of 100 drops formed, between 80-98 drops will contain one particle, far exceeding the number of single particles encapsulated in drops whose statistical distribution in a population of drops follows Poisson statistics.

Although describing the salient components of the idea and demonstrating reduction to practice in one narrow embodiment, there are key elements missing from this description that make the described method less useful than originally described. For example in this particular instance, the fluidic microchannel height is specified to be less than the particle diameter (25 micrometers) and equal in width to the particle diameter (30 micrometers) in order to achieve the close packing of gel beads in the particle reservoir and the transition to 1 D packing in the microchannel leading to the microfluidic junction where the gel bead exits the microfluidic channel and is encapsulated in a drop at a rate such that between 80-98% of drops formed contain one gel bead. This design has multiple deficiencies not obvious to one skilled in the art that could prevent achieving the stated functional goal of high efficiency encapsulation of gel beads in microdroplets. First, the microfluidic channel design intrinsically makes it susceptible to clogging by either debris from external or internal to the microfluidic device or by gel beads that are too big for the microchannel and block its flow. In the case of debris, standard remedies are to ensure a clean operational environment for device usage and to keep clean the workspace during microdevice manufacturing. Gel bead diameter is controlled in either the manufacturing process so the mean gel bead diameter and standard deviation does not exceed the microchannel cross-sectional dimensions or by selecting the gel bead storage buffer to ensure the gel bead diameter does not swell and exceed the specified microfluidic channel dimensions. Furthermore, the transition from a 2D reservoir of particles to the single microfluidic channel requires a long, gradual taper to prevent clogging of particles during the transition from a 2D close-packed configuration to one where the gel beads proceed singly and in single file through the microfluidic channel into the drop-forming junction. As the particles become close packed in the channel, any small differences in particle diameter results in an increased pressure to move the particles through the microfluidic channel. As those particles exit the channel, the sudden release in pressure results in an acceleration of particles exiting the microchannel (a “burst”) and this continues until the pressure returns to a steady-state. The result is that more than one gel bead could be encapsulated in a drop thereby leading potentially more than one barcode tagging the nucleic acid from a cell co-encapsulated with the gel beads in the drop. Finally, the gel bead viscoelastic composition and cross-linking is not specified and the viscoelasticity will play a critical role in the packing and movement of gel beads through the microchannel into the drop forming reservoir. Deformation of the particles to form a 2D monolayer is highly dependent on the elastic modulus of the gel forming the particles and for hydrogels like polyacrylamide and other related polymers, the elastic modulus is highly dependent on the percentage of cross-linked monomers. The degree of cross-linking and subsequent compliance (or conversely stiffness) of the gel particle is a critical parameter to the success or failure of the close packing encapsulation process. Furthermore, movement of the gel particle through the microfluidic channel depends on the compliance (or conversely stiffness) of the gel particle, the particle diameter, compliance (stiffness) of the microchannel wall material and the static and sliding friction between the gel particle and either the microchannel wall material, the liquid interface between the microchannel wall and the gel particle or the interface between the gel particles. There will be a range of these mutually interdependent factors which critically determines the success of the close pack loading method. Such factors include frictional force between the gel beads and walls of the microfluidic channel, interactions between the gel beads that may cause them to stick together, small differences in channel dimensions which would cause the gel beads to jam in the microfluidic channel, or the elastic modulus of the gel beads which would make them too stiff such that the gel beads jam in the microchannel when close packed and do not flow to the microchannel exit. These are non-limiting examples that will negatively impact the ability to achieve a close pack configuration of the gel beads and a subsequent high efficiency of gel bead encapsulation in individual drops. Accordingly, the Abate design therefore makes the microfluidic system highly susceptible to clogging by debris or gel beads, thereby decreasing significantly and preventing one skilled in the art to replicate the reported high efficiency of dispensing single gel beads into individual microdrops.

In a second approach, a focused laser can be used to optically trap and guide particles for single particle encapsulation over a range of sizes (tens of micrometers to a few micrometers). This method is difficult to use, is expensive since it requires specialized laser instrumentation and beam guiding optics and is slow with a maximum speed of a few hertz. A third approach is based on the inertial effects under appropriate flow conditions that leads to regular spacing of particles in the flow stream. Efficient encapsulation can be achieved by matching the periodicity of the drop formation with the periodicity of the particles. While simple and fast, this method is not robust, requires a specialized microfluidic system, is hard to control and is difficult to implement.

A preferred embodiment would combine the best attributes of these different methods to enable high efficiency loading and control of loading and encapsulating one, or a specified number of particles into one drop (e.g. >90%) with a low percentage of drops with no particles (e.g. <10%) and an even lower percentage with two or more particles (<1%). Multiple useful applications arise from this capability, particularly when specific molecules are attached to or associated with the particles to implement assays of single cells in the drops. These molecules could act as unique identifiers or labels of specific molecular species such as nucleic acids, proteins, lipids and polysaccharides derived from an individual cell co-encapsulated in the drop with the labeled particle; or the molecules could be used to label or capture on the particle specific ligands secreted by an individual cell; or the molecules attached to or associated with the particle could be used to specifically interact with the cell co-encapsulated in the drop to identify a specific cell type or cell state from a heterogeneous collection of cells.

### SUMMARY OF THE INVENTION

The present invention generally relates to the methods and systems for encapsulation of particles in microfluidic droplets that overcome the limitations of random loading and other related techniques and resulting in a method and system for efficiently encapsulating a controllable number of particles in each droplet with a method and device that is non-obvious relative to the prior art. The subject matter of the present invention involves, in some cases, interrelated products, alternative solutions to a particular problem, and/or a plurality of different uses of one or more systems and/or articles.

In one aspect, the present invention is generally directed to a method. In one set of embodiments, the method includes providing a microfluidic channel with a height-to-width ratio and the particle diameter-to-channel ratio that results in the close packing of the gel particles in the vertical dimension. This embodiment is not limited to rectangular channels but describes any channel defined by two orthogonal axes. In one set of embodiments, the method includes providing a particle composed of a polymer material with an elastic modulus such that the pressure required to move the particle through a microfluidic channel does not exceed the burst pressure of the microfluidic device. In a second set of embodiments, the method includes providing a particle composed of a polymer material with an elastic modulus such that the structural integrity of the particle is maintained as the particle is deformed in the microchannel. In a third set of embodiments, the solid-to-liquid ratio of gel beads to carrier fluid in a close-packed configuration is above the threshold where adjacent gel beads stick to each other and impede or block the flow of gel beads through the microchannel into the drop formation junction. The flow rate for the gel beads into the drop forming junction equals the flow rate of drops formed on exiting the drop forming junction. Matching of the gel bead and drop formation flow rates can be achieved by changing the rate at which gel beads enter into the junction or the flow rate of the hydrophobic oil forming the drops. In one set of embodiments, the method includes encapsulating a set of cells in aqueous droplets in a hydrophobic oil in a flow stream; encapsulating a set of gel beads in aqueous droplets in a hydrophobic oil in a flow stream; combining the two flow streams; co-encapsulating at least two drops from each flow stream in the same drop defined by the two aqueous drops in is hydrophobic oil surrounding by an aqueous phase and applying a pulsed electric or acoustic field or a chemical stimulus to merge the two aqueous drops inside the oil drop together. In an additional embodiment a photosensor detects the optical emission generated by a focused laser beam from each drop and the photosignal is processed to determine either to energize the electric field or surface acoustic device to apply electric or acoustic energy to merge the two drops.

In particular, a first aspect of the present invention refers to a method of ordering, sorting and/or focusing particles, the method comprising leading the particles through a microfluidic channel comprising a channel height (H) in the range of 1.8 D to 1.2 D, wherein D is the particle diameter.

In another aspect, the present invention is generally directed to a device. In one set of embodiments, the device includes providing a microfluidic channel with a rectangular cross-section and a height-to-width ratio and the particle diameter-to-channel ratio resulting in the close packing of the gel particles in the vertical and horizontal dimension that overcomes the deficiencies of the current art. For a particle diameter D, in certain embodiments the channel height (H) is in the range of 1.8 D to 1.2 D and a channel width (W) range between 1.33 D to 1 D. A channel width less than or equal to the particle diameter allows the particle to close pack along the channel length leading into the drop forming region. This embodiment is not limited to rectangular channels but describes any channel defined by two orthogonal axes with the minor axis smaller than the major axis. In addition to a rectangular cross-section, the invention description would also cover, for example, channels with an elliptical cross-section wherein the major axis is in the range of 1.8 D to 1.2 D and the minor axis is 1.33 D to 1 D.

In particular, a second aspect of the present invention refers to a microfluidic channel system comprising at least one microfluidic channel wherein the channel height (H) is in the range of 1.8 D to 1.2 D and the channel width (W) is in the range of 1.33 D to 1 D, wherein D is the particle diameter.

In a third aspect, the present invention is directed to the use of the method according to the first aspect or a system according to the second aspect for encapsulation of particles in microfluidic droplets.

In a fourth aspect, the present invention is directed to a method of ordering, sorting and/or focusing particles, the method comprising leading the particles through a microfluidic channel comprising is an inner cross section which can be rectangular or elliptic and which size is defined by a major and a minor orthogonal axe, wherein the major orthogonal axe is in the range of 1.8 D to 1.2 D and the minor diagonal axis is in the range of 1.33 D to 1 D wherein D is the particle diameter.

Other advantages and novel features of the present invention will become apparent from the following detailed description of various non-limiting embodiments of the invention when considered in conjunction with the accompanying figures.

### DETAILED DESCRIPTION OF THE INVENTION

The present invention generally relates to the methods and systems and their use for encapsulation of particles in microfluidic droplets that overcome the limitations of random loading and other related techniques and resulting in a method and system for efficiently encapsulating a controllable number of particles in each droplet. In certain aspects, close packed stacking of deformable particles in the vertical dimension of a microchannel provides specific advantages in achieving the objective of encapsulating a large percentage, typically greater than 90% but not less than the percentage possible determine by Poisson statistics, of particles into drops. One factor impacting the spacing between particles in the direction of fluid flow is the 3D close packing of the particulate.

By creating a channel height larger than the diameter of the particulate, two ordered sheets of particulates are formed on top of one another. This allows for higher packing efficiency versus a single sheet as described by Abate, reducing the total volume of extraneous fluid surrounding the particulate. By reducing the fluid surrounding the particulate, the particulate is more readily able to maintain contact when moving single file into the microfluidic junction to be loaded sequentially into droplets. Soft, deformable particles under compression lead to greater contact area between adjacent particles ensuring continuous contact and high efficiency volume packing. Furthermore, in the 3D close packing regime, the distance between sphere centers projected on the plane of the microfluidic device will be 18% closer versus 2D packing yet remain offset from the adjacent particle. For non-spherical shapes the particle centers will be packed closer but by a different amount. The 3D close packed configuration is a preferred embodiment for high efficiency loading of particles into drops because the particles are geometrically packed closer to each other yet the configuration still allows the particles to enter one by one into the drop forming junction. As the leading particle exits the channel, the adjacent particle in contact with the lead particle moves in behind and is positioned to next exit from the microchannel. In this way a steady, continuous yet discrete flow of particles enters the droplet forming junction at a constant rate. A key benefit of is this packing configuration is the rate of particles entering the drop making junction is less sensitive to fluctuations in pressure and flow, allowing single particulate to be loaded sequentially into droplets more consistently, achieving typically greater than 90% of drops containing one particulate with the remainder drops either having no particulate or more than one particulate. This benefit is of particular importance in the event of a particulate partially blocking or occluding the microchannel through which the particles pass.

In one embodiment, close packing of particles in the vertical dimension is achieved when the width (W) of the microchannel, in the single file loading region, is between 1 D to 0.67 D and the height (H) of the microchannel is between 1.2 D to 1.8 D, where D is the particle diameter. As used herein the terms “width” and “height” refer to the direction that is, respectively, perpendicular or parallel to the flow direction in the microchannel. It is critical for the particles to aggregate in a reservoir chamber before entering, single file, into the microchannel. It is in this chamber the 3D close packing structure occurs. The chamber height may be 1.2 to 1.8 times the diameter of the particles to achieve the close packing configuration, but the chamber width could be much greater as long as the particles are close packed in the larger chamber. The chamber width can be at least twice the particle diameter or larger.

In one embodiment of the present invention, the microfluidic channel comprises a chamber for a particle reservoir, wherein the chamber height requires 1.2 to 1.8 times the particle diameter and the chamber width is at least greater than twice the particle diameter. In addition to chamber height, the specific geometry may include tapered lines leading to the microchannel where the particles will align. This geometric shape gives the ideal 3D overlap structure along with providing the least amount of resistance for the particles to reach the channel and is needed to achieve the high efficiency particle loading in drops. The particles effectively form a close packed structure but in three-dimensions, different from the two-dimensional monolayer as described so far. In a microchannel with the cross-sectional dimensions as described, the particles assemble into a close packed, three-dimensional configuration that enables the particles to transition to single file through the microchannel and enter sequentially into the drop forming junction to be encapsulated in a drop. In this configuration, the particles are in contact with their nearest neighbor in the direction of motion; a necessary and sufficient condition for non-random is loading of particles into drops to occur. Increasing the microchannel dimensions beyond the prescribed limits results in the particles no longer in a close packed configuration and thereby resulting in a random loading of particles into drops.

According to another embodiment, the chamber comprises tapered lines leading to the microchannel.

The junction into which the particles enter consists in one embodiment of a chamber fluidically connected to multiple channels that carry fluid from different reservoirs where they combine with a single particle before exiting into another fluidic channel. Each fluidic channel may carry different reagents or cells to initiate a reaction or to assay the cell activity or secretory product. The fluid enters a downstream T junction into which hydrophobic oil flows and a drop forms when the oil flow is momentarily interrupted when a particle blocks the flow of oil and the oil fills in behind the particle as it passes through the junction. The chamber is at least the width and height of the particle to facilitate the particle volume. In a preferred embodiment, the channel dimensions are similar to the particle so as to limit the number of particles in the chamber in any given time.

In one embodiment, the particles enter a downstream T junction into which hydrophobic oil flows and a droplet is formed by the hydrophobic oil when this oil is momentarily interrupted when the particle blocks the flow of oil and the oil fills behind the particle as it passes through the junction.

In another embodiment, the particles enter a downstream T junction into which hydrophobic oil flows and a droplet is formed by the hydrophobic oil when this oil is during the transit time of the particle through the junction, when the particle blocks the flow of oil and the oil fills behind the particle as it passes through the junction after the particle has passed through the junction.

There are multiple distinct advantages in implementing this microchannel configuration. First, the three-dimensional close packed configuration provides openings for the flow of liquid and particles in the event of a partial occlusion of the microchannel by debris. Full or partial blockage of a microfluidic channel can render an entire microfluidic device inoperable; therefore, enabling the ability for particles and liquid to continually flow past a partially blocked or occluded region of the microchannel is highly desirable. Typically, the pressure driving fluid and particles through the microchannel changes depends on the resistance to flow in the microchannel. A pressure difference between the channel inlet and outlet is applied to initiate and provide the force to cause the fluid is and particles to move through the microchannel. The flow resistance increases if the channel is partially blocked either from debris or an oversized particle and this requires an increase in pressure to keep the flow rate through the microchannel constant. Microchannel blockage can be a major impediment to reliable microdevice function and prevent routine usage of the device. Materials typically blocking a microchannel include fibers, dust particles and air bubbles. Once the blockage is removed the pressure difference returns to its original value. The 2D close packing of particles in a microchannel is susceptible to channel blockage by debris. Therefore, another benefit of the three-dimensional stacking is the elimination of the need to change pressure or flow rate in the event of a blockage since the particle arrangement inside the microchannel allows for a continuous flow of liquid and particles past the blockage. In a third benefit, three-dimensional stacking of the particles allows the microchannel connected to the drop forming junction to be shorter and perhaps even eliminated, therefore decreasing the overall size of the microfluidic device. A fourth benefit is that the three-dimensional stacking of the particles decreases the distance the particles need to travel before entering the drop forming junction therefore allowing a higher rate of particle encapsulation in drops for the same applied pressure or flow rate.

In one embodiment of the present invention, the particles are packed in the chamber before entering the microfluidic channel.

A second critical determinant to achieve close packing of p articles in a microfluidic channel are the physiochemical properties of the material comprising the particles. Deformable particles are able to achieve a higher volume packing efficiency with reduced likelihood of blockage in the close packed three-dimensional structure and the elastic modulus of the material comprising the particle directly links the amount of particle deformation to the pressure applied to the particle. For the same applied pressure, a high elastic modulus material will result in a smaller deformation of the particle than a low elastic modulus material. In other words, a high elastic modulus material is less compliant than a low elastic modulus material. In the event where the particle is a hydrogel made from cross-linked polyacrylamide or a similar and related polymer, the percentage of cross-linked monomers in the polymer is an important determinant of elastic modulus and therefore material compliance. In general, the lower the percentage of cross-linked polymer, the lower the elastic modulus and the higher the compliance. To set an upper limit on the particle elastic modulus (E_{particle}), a balance of forces analysis indicates E_{particle}<<Bₛ, where Bₛ is the elastic modulus for the material comprising the microfluidic channel wall. The elastic modulus of polyacrylamide gels is a well-studied and established science in the prior art. The amount of cross linker and total acrylamide can be varied to reliably adjust the elastic modulus of a polyacrylamide gel by at least two orders of magnitude and the elastic modulus can be reliably predicted from a given mixture of acrylamide and molar percentage of monomer cross-linker. There are various methods for measuring the elastic modulus of gel polymers and polyacrylamide gels in particular. The ball indentation method, atomic force microscopy, linear tensile testing, as well as additional techniques are summarized in the references provided herein (Gautreau et al., Bachelor of Science Thesis, “Characterizing the Viscoelastic Properties of Polyacrylamide Gels”, Worcester PolyTechnic Institute, Apr. 27, 2006 Densin, A. K. and Pruitt, B. L, “Tuning the range of polyacrylamide gel stiffness for mechanobiology applications”, ACS Applied Material Interfaces, 2016, 8 (34):21893-21902; Yara Abidine, Valérie Laurent, Richard Michel, Alain Duperray, Liviu lulian Palade, et al. Physical properties of polyacrylamide gels probed by AFM and rheology. EPL—Europhysics Letters, European Physical Society/EDP Sciences/Società Italiana di Fisica/IOP Publishing, 2015, 109, 38003). For a microfluidic channel fabricated from polydimethylsiloxane (PDMS) the elastic modulus is reported to be in the range 117-186 MPa and depends on the PDMS component ratio cure temperature. The elastic modulus of polyacrylamide gels ranges from ^{˜}0.05 MPa for 1 mol % of cross-linking bis monomer to ^{˜}0.4 MPa for 6 mol % cross-linking, thereby satisfying the condition of E_{particle}<<Rₛ for cross-linked polyacrylamide in this range.

A third important factor in determining high occupancy of loading of particles into drops is dependent on achieving a close packed configuration of gel beads without clogging and blocking the flow of particles through the microchannel fluidic channel, preventing them from reaching the drop forming region. Adhesion and friction between particles are dependent on the particle material; the carrier liquid in which the particles are immersed; the rate at which particles are introduced into the particle microchannel; and, the ratio of solid to liquid in the close packed particles.

Modifications to the particle material manifest on the particle surface or surface modifications to the particle itself can cause the particles to adhere or stick to each other in the close packed configuration. One example is streptavidin or biotin linked to the gel polymer, such as polyacrylamide, from which the particle is synthesized. Packing the surface modified particles into a close packed configuration causes them to adhere to one another, resulting in either the particles not flowing through the microfluidic channel and clogging or multiple particles that are stuck is together becoming co-encapsulated in the same drop.

Similarly, the surface wetting properties of the material forming the microchannel is another component determining the ability to close packing of particles in three-dimensions in the microchannel. The microchannel material itself can be hydrophobic, such as a high molecular weight hydrocarbon like a wax, or the interior surface of the channel can be physically or chemically treated to be made hydrophobic. Examples of physical treatments include a formed or structured on a nanometer scale to become hydrophobic, flurophilic or the interior surface of the channel such as a nanostructured surface that traps gas (e.g. air) on the nanometer scale that makes the surface hydrophobic. Examples of chemical surface treatment includes treatment of the microchannel surface with a silane compound in a fluorinated oil to increase the hydrophobicity of the surface against the particles come in contact. This treatment decreases the sliding coefficient of friction between the particles and the microchannel wall and minimizes or eliminates adhesion between the particle and microchannel wall and is particularly effective when the microchannel wall material is PDMS.

The ratio of solid to liquid in the gel bead pack and related number density of gel beads in the close packed configuration can determine if the particles jam pack or flow freely in a microfluidic channel. A dilute solution of gel beads is disordered and flows fluidly. However, when beads are close packed in a more rigid state there are more points of contact between adjacent beads and the surrounding liquid is reduced. Under these conditions the gel beads begin to respond elastically to shear stress more like a semi-solid than a dilute suspension of gel beads in a liquid. In a dilute suspension the number of beads per unit volume is below a critical density and at this point the pressure between the beads is low or zero as there are few if any contact points between adjacent beads. As the bead concentration increases, the number of contact points between the beads grows until a critical density is reached wherein the number of points of contact between gel beads remains constant. Beyond this point, the pressure between beads will be increased, but the number of contacts between adjacent beads will not significantly increase. Creating a geometry such as the bead nozzle, which puts pressure on beads trying to pass through the nozzle and is therefore crucial to maintaining jam packed beads.

It is important to maximize the number of contacts between adjacent beads in order to maintain a consistent, reproducible flow of gel beads exiting the bead microchannel. By creating a geometry that allows for a three dimensional packing structure, the number of contact points is increased is compared to a monolayer of gel beads. As one bead exits there must be another directly adjacent and in contact with no or minimal space between adjacent gel beads to ensure the close pack configuration is met and to ensure the transition of each gel bead into the drop forming region continuous and uninterrupted. The critical packing density of gel beads beyond which the gel particles will jam pack in the microchannel has been determined for a three-dimensionally packed soft gel bead structure to be 64% —in other words 64% of the volume is occupied by gel beads and the remainder by liquid. This occupied volume can be larger, up to 100%, depending on the pressure applied by the geometry and flow rate as well as the elastic modulus of the beads. It is important to design the system in such a way that the channel height allows for three-dimensional packing, the width creates a restriction maintaining a pressure between the beads, and the beads are of an elastic modulus and initial concentration to maintain jammed packing and consistent bead flow. These design criteria when combined indicate a necessary relationship between the major and minor axes of a microfluidic channel with a symmetrical cross-section. Preferred embodiments would include but not be limited to microchannels with a rectangular or ellipsoidal cross-section with a major axis (Ma) and a minor axis (Mi).

In one embodiment, the Ma/Mi ratio is in the range of 2.69-1.20, where Ma is between 1.8 D-1.2 D and Mi is between 1 D-0.67 D, where D is the diameter of the particle. One non-limiting example would be a microfluidic channel with a rectangular cross-section into which particles of 60 micrometers are injected. The channel cross-sectional dimensions to achieve close packing of the particles without jamming would then be in the range of 72-108 micrometer in height by 40-60 micrometer in width. Tolerances on the microchannel and gel bead dimensions would be +/−2 micrometer maximally.

In another embodiment, the Ma/Mi ratio is in the range of 1.8-0.90, where Ma is between 1.8 D-1.2 D and Mi is between 1 D-1.33 D, where D is the diameter of the gel bead. One non-limiting example would be a microfluidic channel with a rectangular cross-section into which gel beads of 60 micrometers are injected. The channel cross-sectional dimensions to achieve close packing of the gel beads without jamming would then be in the range of 72-108 micrometer in height by 60-80 micrometer in width. Tolerances on the microchannel and gel bead dimensions would be +/−2 micrometer maximally.

There is no intrinsic limit on the scaling of microfluidic channel dimensions relative to gel bead diameter to meet the criteria for close pack injection of gel beads into microfluidic drops. The microfluidic channel cross-section can be scaled to accommodate gel bead diameters ranging from less than 1 micrometer to more than 500 micrometers.

In another embodiment where the channel cross-section is asymmetric the bead diameter equals the largest cross-sectional dimension of the channel.

In one embodiment, the particles are composed of a polymer material with an elastic modulus dependent on the molar percentage of cross-linked monomer. For a preferred embodiment of polyacrylamide gels, the preferred range of elastic modulus is ^{˜}0.05 MPa for 1 mol % of cross-linking bis monomer to ^{˜}0.4 MPa for 6 mol % of cross-linked monomer.

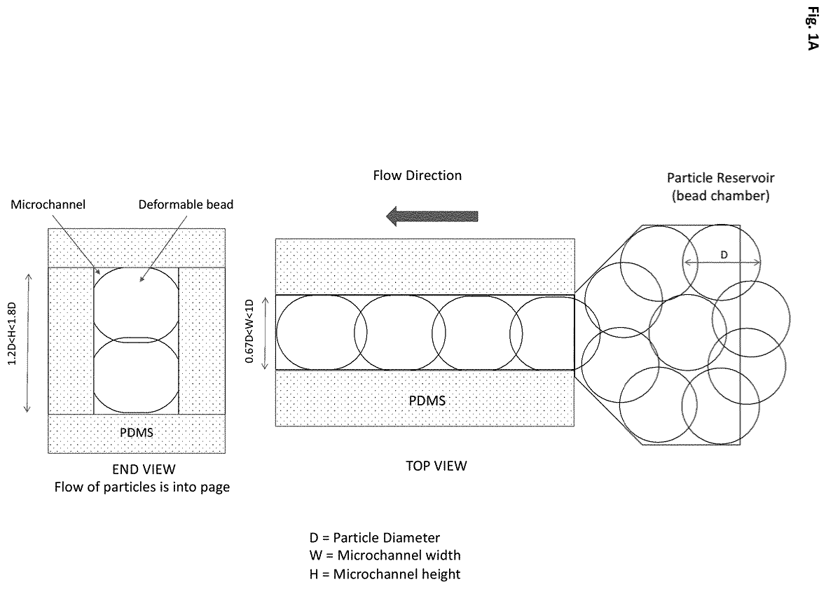

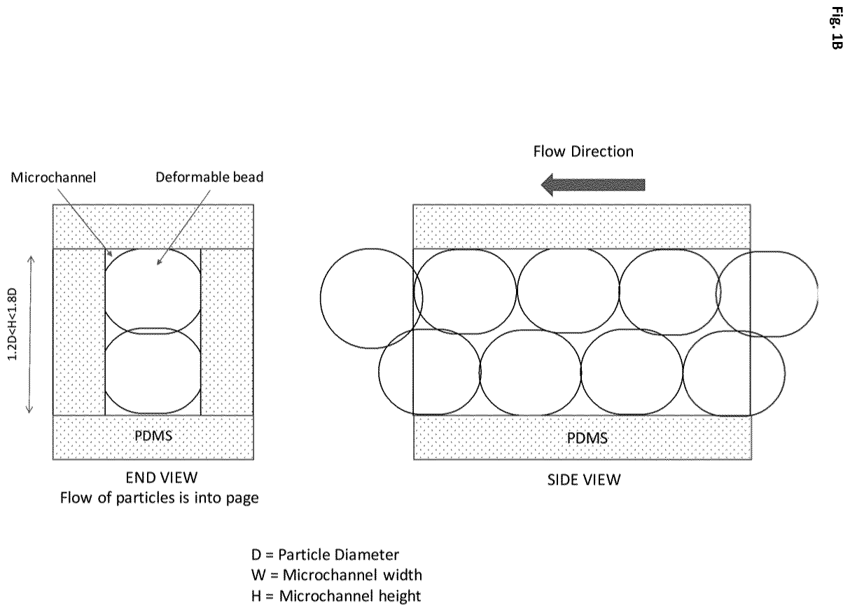

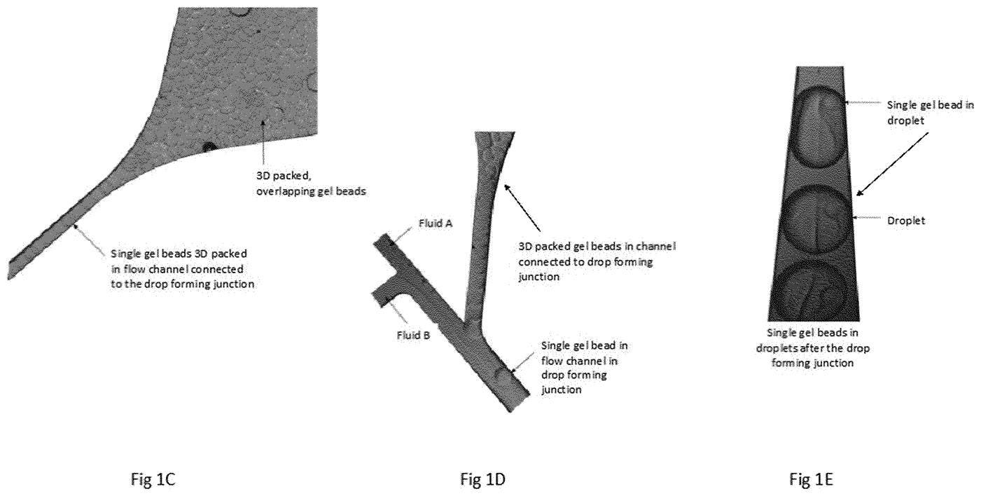

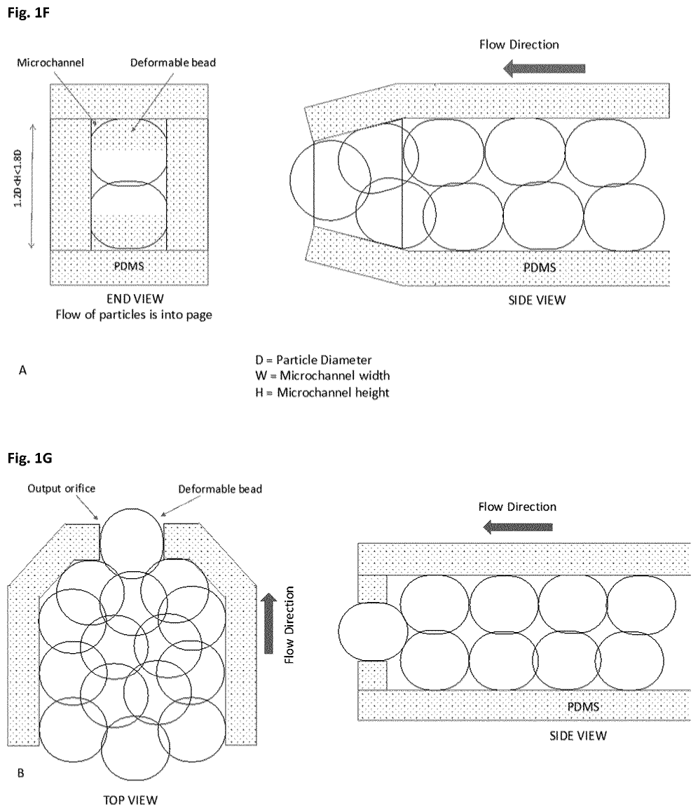

In one embodiment, the microfluidic channel height is decreased at the exit. Preferably, the microfluidic channel height and width is decreased at the exit to form a nozzle equal to the particle diameter (see FIGS. 1F-G).

The flow rate and hydraulic resistance to the flow in the microchannel will determine the initial conditions for achieving the close pack configuration of the gel beads needed to achieve the desired high occupancy rate in the droplets. To achieve the desired hydraulic resistance to maximize gel bead contact points for a given set of flow conditions, the microchannel height (H) is between 1.2 D-1.8 D and the dimensions of the microchannel connecting to the drop forming junction has a height (H) is between 1.2 D-1.8 D and width (W) is between 1.33 D-1 D, where D is the gel bead (or particle) diameter. At high flow rate, the gel beads quickly fill the microfluidic channel and because of the hydraulic resistance at the microfluidic channel outlet, the beads take on a close packed configuration in three-dimensions. Once the close pack configuration is achieved, the flow rate can be adjusted such that the rate of beads exiting the microchannel equals the rate of formation of droplets exiting the drop formation region, resulting in a high (+90%) occupancy of beads exiting the drop formation region.

In a first aspect, the present invention refers to a method of ordering, sorting and/or focusing particles, the method comprising leading the particles through a microfluidic channel comprising a channel height (H) in the range of 1.8 D to 1.2 D, wherein D is the particle diameter.

In one embodiment, the microfluidic channel comprises a channel width (W) in the range of 1.33 D to 1 D. In another embodiment, the H/W ratio for the microfluidic channel is in the range of 1.8-0.90 D, wherein D is the particle diameter.

In greater description of this embodiment, one preferred approach is to first spin down the particles to form a concentrate in the bottom of the container and then aspirate the particles into a high aspect ratio tube where the particle diameter to tube diameter ratio is maximally 1:20. The particles are aspirated into the tubing with one end of the tube in the particle concentrate and it is critical the particles in the tubing form a close pack configuration after aspiration. There are two factors to the aspiration and dispensing process that are needed to achieve this condition in the tube and therefore in the microfluidic chamber when the particles are dispensed from the tube. First, it is critical the tube is inserted into the particle concentrate to minimize the amount fluid withdrawn with the particles otherwise the concentration of the particles the concentration of particles being loaded into the tube should be between 200-4000 particles/μl for 75 μm particles or volume packing efficiency between 64%-88% for particles of different diameters. If the particle density is below this range, then the particles will not form a close pack configuration in the tube or when dispensed from the tube conducive for high efficiency droplet encapsulation efficiency. A second critical factor is the rate of aspiration and dispensing of the particles from the tube. If the flow rate of the particles entering or exiting the tube is above a maximum flow rate of 9000 μl/hr then the particles do not form a close pack structure in the tubing nor in the microfluidic chamber into which they are dispensed. In turn, if the particles in the microfluidic chamber are not closely packed then they do not form a close pack structure in the microfluidic channel connected to the drop form junction and the occupancy rate of particles in drops is low.

In a separate instance, it may be desirable to have microfluidic channel with a smaller width to achieve the desired hydraulic resistance that maximizes close packing of the particles into the microfluidic channel exiting into the drop forming region. In this embodiment, the microchannel height-to-width ratio (H/W) is between 2.69-1.20 and the dimensions of the microchannel connecting to the drop forming junction has a height (H) is between to 1.2 D-1.8 D and width (W) is between to 0.67 D-1 D, where D is the particle diameter.

In a first aspect, the present invention refers to a method of ordering, sorting and/or focusing particles, the method comprising leading the particles through a microfluidic channel comprising a channel height (H) in the range of 1.8 D to 1.2 D, where D is the particle diameter.

In one embodiment, the microfluidic channel comprises a channel width (W) in the range of 1.33 D to 1 D and the H/W ratio is 1.8-0.90, where D is the particle diameter.

In another embodiment, the H/W ratio of 1.8-0.90 applies to the major and minor axes of the microchannel cross-section if the channel cross-section is ellipsoidal.

In the event the microchannel cross-section is asymmetric with no defined major and/or minor symmetry axes, such as in the case of a triangular cross-section, the same principle applies to relate the major and minor dimensions in a similar way. In another embodiment, the H/W ratio of 1.8-0.90 applies to the major and minor axes of the microchannel cross-section if the channel cross-section is triangular or an equivalent asymmetrical cross-section. The major axis will be the major symmetry axis of the channel cross-section and the minor axis equal to the largest dimension perpendicular to the symmetry axis. Similar Ma/Mi ratios will be applied to determine the channel dimensional size relative to the injected particle diameter.

A benefit of the microfluidic circuit used to combine different fluids with the particles in a drop (FIG. 1) is that the flow rates of the different fluids and hydrophobic drop forming oil can be fixed and the flow rate of the particles into the drop forming junction adjusted to so as to match the rate of particles entering the junction to the rate of drop formation. This gives the distinct advantage of optimizing the particle flow rate to provide for the highest occupancy rate of particles in drops. In particular, the flow rates can be adjusted to achieve the ratio of droplet-forming oil to aqueous phase of 1:1.2-1.67 for maximum particle occupancy. For example, if the sum of the aqueous flow rates is significantly greater than or less than 600 μl/hr while the oil phase remains at a constant 360 μl/hr, droplet formation will be polydispersed and unstable resulting in multiple particles per drop.

The description of the particle meeting the requirements for high occupancy loading is not limited to homogeneous hydrogel polymers but would also include heterogeneous gel polymers or any other polymer that could be formed into a particle with the physical and chemical properties thus described.

In one embodiment of the present invention, the particles are hydrogel beads.

According to certain aspects, the systems and methods described herein can be used in a plurality is of applications. For example, fields in which the particles and multiple emulsions described herein may be useful include, but are not limited to, food, beverage, health and beauty aids, paints and coatings, chemical separations, agricultural applications, and drugs and drug delivery. For instance, a precise quantity of a fluid, drug, pharmaceutical, or other species can be contained in a particle and encapsulated into a drop designed to release its contents under specific conditions. In another instance, magnetic colloidal particles with specific capture molecules can be incorporated into the hydrogel bead and be useful in selective capture and subsequent magnetic separation of specific ligands or molecules from a heterogeneous mixture. In some instances, cells as a particle can be contained within a droplet, and the cells can be stored and/or delivered, e.g., to a target medium, for example, within a subject. Other species that can be contained within a droplet or particle and delivered to a target medium include, for example, biochemical species such as nucleic acids such as siRNA, RNAi, long non-coding RNA and DNA, proteins, peptides, lipids, carbohydrates, polysaccharides, or enzymes. In another instance, a collection of hydrogel beads to which each are attached a unique oligonucleotide sequence or other molecular identifier in multiplicity are combined in the drop with one cell can act to uniquely barcode label the DNA, RNA or protein of that cell. Additional species that can be contained within a droplet or particle include, but are not limited to, colloidal particles, magnetic particles, nanoparticles, quantum dots, fragrances, proteins, indicators, dyes, fluorescent species, chemicals, or the like. In another instance, different single cell assays in drops are implemented based on a collection of hydrogel beads with a molecule-specific or non-specific capture agent attached to or associated with the hydrogel bead in the droplet with a single cell and an optically active reagent to detect the collection of molecules specifically or non-specifically captured or immobilized in or on the hydrogel bead. Molecules from the cell are captured or immobilized in or on the hydrogel bead and the optically active reagent labels the immobilized molecules to create an optical signal associated with or localized to the hydrogel bead. This is particularly advantageous when detecting the presence of molecules attached to the hydrogel bead in a flow cytometry configuration in that the optical signal localized to the hydrogel bead is now localized in time as the drop moves past the optical excitation and detection region of the flow channel. The porous nature of the hydrogel bead allows for loading and/or capture of a larger volume of target molecules on the surface and within the volume of the hydrogel bead, resulting a high detection sensitivity and dynamic range of detection. These features are particularly important in detecting low levels of IgG secreted from an encapsulated B cell plasmablast or cytokines from an activated T cell in the drop with the hydrogel bead. Additionally, more than one capture or target reagent can be immobilized in the hydrogel bead to enable detection of more than one reagent and in different combinations. This could be useful, for is example, in the detection and simultaneous measurement of protein and RNA molecules from the same cell. A similar principle applies for a static imaging system where the optical signal is spatially associated with the hydrogel bead and is readily discerned from any background signal, as is the case for the flow example. Furthermore, the high binding capacity of molecules to the hydrogel bead means molecules from a single cell can be detected at low number and over a large dynamic range.

In one embodiment of the present invention, the combination of mechanically compliant gel beads labeled with one or more reagent with a microfluidic circuit that combines single gel beads with optically labeled cells and/or reagents in single drops results in the ability to perform at high throughput single cell assays via optical emission, absorption or scattering of light from the labeled reagents and cells.

In one embodiment of the present invention, the particles comprise capture molecules.

In a further embodiment, the capture molecules may be selected from the group comprising, an antigen, an antibody or fragments thereof, nucleic acids, magnetic particles, colloidal particles, nanoparticles, quantum dots, small molecules, proteins, indicators, dyes, fluorescent species and chemicals.

The target medium may be any suitable medium, for example, water, saline, an aqueous medium, a hydrophobic medium, or the like.

The droplets may be microfluidic droplets, in some instances. For instance, the outer droplet may have a diameter of less than about 1 mm, less than about 500 micrometers, less than about 200 micrometers, less than about 100 micrometers, less than about 75 micrometers, less than about 50 micrometers, less than about 25 micrometers, less than about 10 micrometers, or less than about micrometers, or between about 50 micrometers and about 1 mm, between about 10 micrometers and about 500 micrometers, or between about 50 micrometers and about 100 micrometers in some cases. However, in some cases, the droplets may be larger. For example, the inner droplet (or a middle droplet) of a triple or other multiple emulsion droplet may have a diameter of less than about 1 mm, less than about 500 micrometers, less than about 200 micrometers, less than about 100 micrometers, less than about 75 micrometers, less than about 50 micrometers, less than about micrometers, less than about 10 micrometers, or less than about 5 micrometers, or between about 50 micrometers and about 1 mm, between about 10 micrometers and about 500 micrometers, or between about 50 micrometers and about 100 micrometers in some cases.

The particles (e.g., gel particles) or droplets described herein may have any suitable average cross-sectional diameter. Those of ordinary skill in the art will be able to determine the average cross-sectional diameter of a single and/or a plurality of particles or droplets, for example, using laser light scattering, microscopic examination, or other known techniques. The average cross-sectional diameter of a single particle or droplet, in a non-spherical particle or droplet, is the diameter of a perfect sphere having the same volume as the non-spherical particle or droplet. The average cross-sectional diameter of a particle or droplet (and/or of a plurality or series of particles or droplets) may be, for example, less than about 1 mm, less than about 500 micrometers, less than about 200 micrometers, less than about 100 micrometers, less than about 75 micrometers, less than about 50 micrometers, less than about 25 micrometers, less than about 10 micrometers, or less than about micrometers, or between about 50 micrometers and about 1 mm, between about 10 micrometers and about 500 micrometers, or between about 50 micrometers and about 100 micrometers in some cases. The average cross-sectional diameter may also be at least about 1 micrometer, at least about 2 micrometers, at least about 3 micrometers, at least about 5 micrometers, at least about 10 micrometers, at least about 15 micrometers, or at least about 20 micrometers in certain cases. In some embodiments, at least about 50%, at least about 75%, at least about 90%, at least about 95%, or at least about 99% of the particles or droplets within a plurality of particles or droplets has an average cross-sectional diameter within any of the ranges outlined in this paragraph.

The plurality of particles (e.g., gel particles) or droplets may have relatively uniform cross-sectional diameters in certain embodiments. The use of particles or droplets with relatively uniform cross-sectional diameters can allow one to control viscosity, the amount of species delivered to a target, and/or other parameters of the delivery of fluid and/or species from the particles or droplets. In some embodiments, the particles or droplets of particles is monodisperse, or the plurality of particles or droplets has an overall average diameter and a distribution of diameters such that no more than about 5%, no more than about 2%, or no more than about 1% of the particles or droplets have a diameter less than about 90% (or less than about 95%, or less than about 99%) and/or greater than about 110% (or greater than about 105%, or greater than about 101%) of the overall average diameter of the plurality of particles or droplets.

In some embodiments, the plurality of particles or droplets has an overall average diameter and a distribution of diameters such that the coefficient of variation of the cross-sectional diameters of the particles or droplets is less than about 10%, less than about 5%, less than about 2%, between about 1% and about 10%, between about 1% and about 5%, or between about 1% and about 2%. The coefficient of variation can be determined by those of ordinary skill in the art, and may be defined as:

$${c}_{v} = \frac{σ}{\vert μ \vert} ,$$

wherein σ is the standard deviation and p is the mean.

In certain aspects of the present invention, as discussed, multiple emulsions are formed by flowing fluids through one or more channels, e.g., as shown in FIG. 1C. The system may be a microfluidic system. “Microfluidic,” as used herein, refers to a device, apparatus, or system including at least one fluid channel having a cross-sectional dimension of less than about 1 millimeter (mm), and in some cases, a ratio of length to largest cross-sectional dimension of at least 3:1. One or more channels of the system may be a capillary tube. In some cases, multiple channels are provided, and in some embodiments, at least some are nested, as described herein. The channels may be in the microfluidic size range and may have, for example, average inner diameters, or portions having an inner diameter, of less than about 1 millimeter, less than about 300 micrometers, less than about 100 micrometers, less than about 30 micrometers, less than about 10 micrometers, less than about 3 micrometers, or less than about 1 micrometer, thereby providing droplets having comparable average diameters. One or more of the channels may (but not necessarily), in cross-section, have a height that is substantially the same as a width at the same point. In cross-section, the channels may be rectangular or substantially non-rectangular, such as circular or elliptical.

As used herein, the term “fluid” generally refers to a substance that tends to flow and to conform to the outline of its container, i.e., a liquid, a gas, a viscoelastic fluid, etc. In one embodiment, the fluid is a liquid. Typically, fluids are materials that are unable to withstand a static shear stress, and when a shear stress is applied, the fluid experiences a continuing and permanent distortion. The fluid may have any suitable viscosity that permits flow. If two or more fluids are present, each fluid may be independently selected among essentially any fluids (liquids, gases, and the like) by those of ordinary skill in the art, by considering the relationship between the fluids.

A variety of materials and methods, according to certain aspects of the invention, can be used to form articles or components such as those described herein, e.g., channels such as microfluidic channels, chambers, etc. For example, various articles or components can be formed from solid materials, in which the channels can be formed via micromachining, film deposition processes such as spin coating and chemical vapor deposition, laser fabrication, photolithographic techniques, etching methods including wet chemical or plasma processes, 3D printing, and the like.

In one set of embodiments, various structures or components of the articles described herein can be formed from glass or a polymer, for example, an elastomeric polymer such as polydimethylsiloxane (“PDMS”), polytetrafluoroethylene (“PTFE” or Teflon®), epoxy, norland optical adhesive, or the like. For instance, according to one embodiment, microfluidic channels may be formed from glass tubes or capillaries. In addition, in some cases, a microfluidic channel may be implemented by fabricating the fluidic system separately using PDMS or other soft lithography techniques (details of soft lithography techniques suitable for this embodiment are discussed in the references entitled “Soft Uthography,” by Younan Xia and George M. Whitesides, published in the Annual Review of Material Science, 1998, Vol. 28, pages 153-184, and “Soft Uthography in Biology and Biochemistry,” by George M. Whitesides, Emanuele Ostuni, Shuichi Takayama, Xingyu Jiang and Donald E. Ingber, published in the Annual Review of Biomedical Engineering, 2001, Vol. 3, pages 335-373). In addition, in some embodiments, various structures or components of the articles described herein can be formed of a metal, for example, stainless steel.

Other examples of potentially suitable polymers include, but are not limited to, polyethylene terephthalate (PET), polyacrylate, polymethacrylate, polycarbonate, polystyrene, polyethylene, polypropylene, polyvinylchloride, cyclic olefin copolymer (COC), polytetrafluoroethylene, a fluorinated polymer, a silicone such as polydimethylsiloxane, polyvinylidene chloride, bis-benzocyclobutene (“BCB”), a polyimide, a fluorinated derivative of a polyimide, or the like. Combinations, copolymers, or blends involving polymers including those described above are also envisioned. The device may also be formed from composite materials, for example, a composite of a polymer and a semiconductor material.

In some embodiments, various structures or components of the article are fabricated from polymeric and/or flexible and/or elastomeric materials, and can be conveniently formed of a hardenable fluid, facilitating fabrication via molding (e.g. replica molding, injection molding, cast molding, etc.). The hardenable fluid can be essentially any fluid that can be induced to solidify, or that spontaneously solidifies, into a solid capable of containing and/or transporting fluids is contemplated for use in and with the fluidic network. In one embodiment, the hardenable fluid comprises a polymeric liquid or a liquid polymeric precursor (i.e. a “prepolymer”). Suitable polymeric liquids can include, for example, thermoplastic polymers, thermoset polymers, waxes, or mixtures or composites thereof heated above their melting point. As another example, a suitable polymeric liquid may include a solution of one or more polymers in a suitable solvent, which solution forms a solid polymeric material upon removal of the solvent, for example, by evaporation. Such polymeric materials, which can be solidified from, for example, a melt state or by solvent evaporation, are well known to those of ordinary skill in the art. A variety of polymeric materials, many of which are elastomeric, are suitable, and are also suitable for forming molds or mold masters, for embodiments where one or both of the mold masters is composed of an elastomeric material. A non-limiting list of examples of such polymers includes polymers of the general classes of silicone polymers, epoxy polymers, and acrylate polymers. Epoxy polymers are characterized by the presence of a three-membered cyclic ether group commonly referred to as an epoxy group, 1,2-epoxide, or oxirane. For example, diglycidyl ethers of bisphenol A can be used, in addition to compounds based on aromatic amine, triazine, and cycloaliphatic backbones. Another example includes the well-known Novolac polymers. Non-limiting examples of silicone elastomers suitable for use according to the invention include those formed from precursors including the chlorosilanes such as methylchlorosilanes, ethylchlorosilanes, phenylchlorosilanes, dodecyltrichlorosilanes, etc.

Silicone polymers are used in certain embodiments, for example, the silicone elastomer polydimethylsiloxane. Non-limiting examples of PDMS polymers include those sold under the trademark Sylgard by Dow Chemical Co., Midland, Mich., and particularly Sylgard 182, Sylgard 184, and Sylgard 186. Silicone polymers including PDMS have several beneficial properties simplifying fabrication of various structures of the invention. For instance, such materials are inexpensive, readily available, and can be solidified from a prepolymeric liquid via curing with heat. For example, PDMSs are typically curable by exposure of the prepolymeric liquid to temperatures of about, for example, about 65° C. to about 75° C. for exposure times of, for example, about an hour, about 3 hours, about 12 hours, etc. Also, silicone polymers, such as PDMS, can be elastomeric and thus may be useful for forming very small features with relatively high aspect ratios, necessary in certain embodiments of the invention. Flexible (e.g., elastomeric) molds or masters can be advantageous in this regard.

One advantage of forming structures such as microfluidic structures or channels from silicone polymers, such as PDMS, is the ability of such polymers to be oxidized, for example by exposure to an oxygen-containing plasma such as an air plasma, so that the oxidized structures contain, at their surface, chemical groups capable of cross-linking to other oxidized silicone polymer surfaces or to the oxidized surfaces of a variety of other polymeric and non-polymeric materials. Thus, structures can be fabricated and then oxidized and essentially irreversibly sealed to other silicone polymer surfaces, or to the surfaces of other substrates reactive with the oxidized silicone polymer surfaces, without the need for separate adhesives or other sealing means. In most cases, sealing can be completed simply by contacting an oxidized silicone surface to another surface without the need to apply auxiliary pressure to form the seal. That is, the pre-oxidized silicone surface acts as a contact adhesive against suitable mating surfaces. Specifically, in addition to being irreversibly sealable or bonded to itself, oxidized silicone such as oxidized PDMS can also be sealed irreversibly to a range of oxidized materials other than itself including, for example, glass, silicon, silicon oxide, quartz, silicon nitride, polyethylene, polystyrene, glassy carbon, and epoxy polymers, which have been oxidized in a similar fashion to the PDMS surface (for example, via exposure to an oxygen-containing plasma). Oxidation and sealing methods useful in the context of the present invention, as well as overall molding techniques, are described in the art, for example, in an article entitled “Rapid Prototyping of Microfluidic Systems and Polydimethylsiloxane,” Anal. Chem., 70:474-480, 1998 (Duffy et al.).

Different components can be fabricated of different materials. For example, a base portion including a bottom wall and side walls can be fabricated from an opaque material such as silicon or PDMS, and a top portion can be fabricated from a transparent or at least partially transparent material, such as glass or a transparent polymer, for observation and/or control of the fluidic process. Components can be coated so as to expose a desired chemical functionality to fluids that contact interior channel walls, where the base supporting material does not have a precise, desired functionality. For example, components can be fabricated as illustrated, with interior channel walls coated with another material, e.g., as discussed herein. Material used to fabricate various components of the systems and devices of the invention, e.g., materials used to coat interior walls of fluid channels, may desirably be selected from among those materials that will not adversely affect or be affected by fluid flowing through the fluidic system, e.g., material(s) that is chemically inert in the presence of fluids to be used within the device. A non-limiting example of such a coating is disclosed below; additional examples are disclosed in Int. Pat. Apl. Ser. No. PCT/US2009/000850, filed Feb. 11, 2009, entitled “Surfaces, Including Microfluidic Channels, With Controlled Wetting Properties,” by Weitz, et al., published as WO 2009/120254 on Oct. 1, 2009.

In one embodiment, the inner wall of the microfluidic channel is hydrophobic.

In some embodiments, certain microfluidic structures of the invention (or interior, fluid-contacting surfaces) may be formed from certain oxidized silicone polymers. Such surfaces may be more hydrophilic than the surface of an elastomeric polymer. Such hydrophilic surfaces can thus be more easily filled and wetted with aqueous solutions.

In some embodiments, a bottom wall of a microfluidic device of the invention is formed of a material different from one or more side walls or a top wall, or other components. For example, in some embodiments, the interior surface of a bottom wall comprises the surface of a silicon wafer or microchip, or other substrate. Other components may, as described above, be sealed to such alternative substrates. Where it is desired to seal a component comprising a silicone polymer (e.g. PDMS) to a substrate (bottom wall) of different material, the substrate may be selected from the group of materials to which oxidized silicone polymer is able to irreversibly seal (e.g., glass, silicon, silicon oxide, quartz, silicon nitride, polyethylene, polystyrene, epoxy polymers, and glassy carbon surfaces which have been oxidized). Alternatively, other sealing techniques may be used, as would be apparent to those of ordinary skill in the art, including, but not limited to, the use of separate adhesives, bonding, solvent bonding, ultrasonic welding, etc.

Thus, in certain embodiments, the design and/or fabrication of the article may be relatively simple, e.g., by using relatively well-known soft lithography and other techniques such as those described herein. In addition, in some embodiments, rapid and/or customized design of the article is possible, for example, in terms of geometry. In one set of embodiments, the article may be produced to be disposable, for example, in embodiments where the article is used with substances that are radioactive, toxic, poisonous, reactive, biohazardous, etc., and/or where the profile of the substance (e.g., the toxicology profile, the radioactivity profile, etc.) is unknown. Another advantage to forming channels or other structures (or interior, fluid-contacting surfaces) from oxidized silicone polymers is that these surfaces can be much more hydrophilic than the surfaces of typical elastomeric polymers (where a hydrophilic interior surface is desired). Such hydrophilic channel surfaces can thus be more easily filled and wetted with aqueous solutions than can structures comprised of typical, unoxidized elastomeric polymers or other hydrophobic materials.

In one set of embodiments, one or more of the channels within the device may be relatively hydrophobic or relatively hydrophilic, e.g. inherently, and/or by treating one or more of the surfaces or walls of the channel to render them more hydrophobic or hydrophilic. Generally, the fluids that are formed droplets in the device are substantially immiscible, at least on the time scale of forming the droplets, and the fluids will often have different degrees of hydrophobicity or hydrophilicity. Thus, for example, a first fluid may be more hydrophilic (or more hydrophobic) relative to a second fluid, and the first and the second fluids may be substantially immiscible. Thus, the first fluid can from a discrete droplet within the second fluid, e.g., without substantial mixing of the first fluid and the second fluid (although some degree of mixing may nevertheless occur under some conditions). Similarly, the second fluid may be more hydrophilic (or more hydrophobic) relative to a third fluid (which may be the same or different than the first fluid), and the second and third fluids may be substantially immiscible.

Accordingly, in some cases, a surface of a channel may be relatively hydrophobic or hydrophilic, depending on the fluid contained within the channel. In one set of embodiments, a surface of the channel is hydrophobic or hydrophilic relative to other surfaces within the device. In addition, in some embodiments, a relatively hydrophobic surface may exhibit a water contact angle of greater than about 90°, and/or a relatively hydrophilic surface may exhibit a water contact angle of less than about 90°.

In some cases, relatively hydrophobic and/or hydrophilic surfaces may be used to facilitate the flow of fluids within the channel, e.g., to maintain the nesting of multiple fluids within the channel in a particular order. Additional details of such coatings and other systems may be seen in U.S. Provisional Patent Application Ser. No. 61/040,442, filed Mar. 28, 2008, entitled “Surfaces, Including Microfluidic Channels, With Controlled Wetting Properties,” by Abate, et al.; and International Patent Application Serial No. PCT/US2009/000850, filed Feb. 11, 2009, entitled “Surfaces, Including Microfluidic Channels, With Controlled Wetting Properties,” by Abate, et al.

Certain aspects of the invention are generally directed to techniques for scaling up or “numbering up” devices such as those discussed herein. For example, in some cases, relatively large numbers of devices may be used in parallel, for example at least about 10 devices, at least about 30 devices, at least about 50 devices, at least about 75 devices, at least about 100 devices, at least about 200 devices, at least about 300 devices, at least about 500 devices, at least about 750 devices, or at least about 1,000 devices or more may be operated in parallel. In some cases, an array of such devices may be formed by stacking the devices horizontally and/or vertically. The devices may be commonly controlled, or separately controlled, and can be provided with common or separate sources of various fluids, depending on the application.

Those of ordinary skill in the art will be aware of other techniques useful for scaling up or numbering up devices or articles such as those discussed herein. For example, in some embodiments, a fluid distributor can be used to distribute fluid from one or more inputs to a plurality of outputs, e.g., in one or more devices. For instance, a plurality of articles may be connected in three dimensions. In some cases, channel dimensions are chosen that allow pressure variations within parallel devices to be substantially reduced. Other examples of suitable techniques include, but are not limited to, those disclosed in International Patent Application No. PCT/US2010/000753, filed Mar. 12, 2010, entitled “Scale-up of Microfluidic Devices,” by Romanowsky, et al., published as WO 2010/104597 on Nov. 16, 2010. Abate et al., Lab Chip, 2009, 9, 2628-263; Johnston et al., J. Micromech Microeng. 2014, 24, 35017; Constantinides et al., J. Biomechanics, 2008, 41, 3285-3289.

Another embodiment of the invention belongs to a method, wherein a drop sorter unit under feedback control of a photosignal detection and processing unit and a further microfluidic channel is provided, wherein a detected positive signal triggers the sorter to energize and apply a pulsed electric or acoustic field to the droplet to redirect the droplet into the further microfluidic channel.

An alternative embodiment of the invention relates to a method, wherein a drop fusing unit under a feedback control and at least one further microfluidic channel is provided, wherein differently loaded drops are leaded through both channels which are connected via a junction, wherein the feedback control is activated by one of the drops and triggers the fusing unit to energize and apply either a pulsed electric or acoustic field to the two differently loaded drops to fuse them to a single larger drop with a volume equal to the sum of the volume of the original two drops prior to fusion.

In another embodiment, the invention relates also to a method comprising encapsulating a set of cells in aqueous droplets in a hydrophobic oil in a flow stream in a first microfluidic system comprising at least one microfluidic channel and a T-junction; encapsulating a set of gel beads in aqueous droplets in a hydrophobic oil in a flow stream in a second microfluidic system comprising at least one microfluidic channel and a T-junction; combining the two flow streams by leading them through the microfluidic channels of the first and the second system which are connected via a junction; co-encapsulating at least two drops from each flow stream in the same drop defined by is the two aqueous drops in hydrophobic oil surrounding by an aqueous phase and applying a pulsed electric or acoustic field to merge the two aqueous drops inside the oil drop together.

A second aspect of the present invention refers to a microfluidic channel system comprising at least one microfluidic channel wherein the channel height (H) is in the range of 1.8 D to 1.2 D and the channel width (W) is in the range of 1.33 D to 1 D, where D is the particle diameter. In one embodiment, the H/W ratio is in the range of 1.8-0.90.

A third aspect of the present invention is directed to the use of the method according to the first aspect or a system according to the second aspect for encapsulation of particles in microfluidic droplets.

In a fourth aspect, the present invention is directed to a method of ordering, sorting and/or focusing particles, the method comprising leading the particles through a microfluidic channel comprising an inner cross section which can be rectangular or elliptic and which size is defined by a major and a minor orthogonal axe, wherein the major orthogonal axe is in the range of 1.8 D to 1.2 D and the minor diagonal axe is in the range of 1.33 D to 1 D wherein D is the particle diameter.

A further aspect of the present invention refers to a microfluidic channel system comprising at least one microfluidic channel wherein the channel height (H) is in the range of 1.8 D to 1.2 D and the channel width (W) is in the range of 0.67 D to 1 D, where D is the particle diameter, and the H/W ratio is in the range of 2.69-1.20.

It would be evident to a person skilled in the art that structural embodiments characterizing the method according to the first aspect also apply for the further aspects of the present invention.

### DETAILED DESCRIPTION OF THE FIGURES

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1A-G illustrates the relationship between the particle and microchannel dimensions and the 3D close packing needed to implement high efficiency encapsulation of a single particle into the droplets.

FIG. 1A: Views of 3D close packing of deformable particles in a microfluidic channel. End view: the particles are constrained by the channel width and are close packed in the vertical direction. Top view: the particles are constrained by the channel width and are close packed in an overlapping configuration vertically.

FIG. 1B: Views of 3D close packing of deformable particles in a microfluidic channel. End view: the particles are constrained by the channel width and are close packed in the vertical direction. Side view: the particles are constrained by the channel width and close packed in an overlapping configuration vertically where the leading edge particle exits the channel into the drop forming junction.

FIG. 1C: Photo of reservoir with close packed gel particles in three dimensions with gel particles in the microfluidic channel connected to the drop forming junction close packed in 3D.

FIG. 1D: Photo of droplet forming junction where microchannels with two different fluids converge and combined with the close-packed gel particles to form drops containing a single gel particle and Fluids A and B.

FIG. 1E: Photo of single gel particles, Fluid A and Fluid B in drops with a gel particle occupancy of +90%.

FIG. 1F: Another embodiment where the channel height is decreased at the exit to form a nozzle equal to the particle diameter. The nozzle is formed by beveling the upper and lower surfaces of the microchannel.

FIG. 1G: A third embodiment where the channel height is decreased at the exit to form a nozzle equal to the particle diameter but the channel width is larger than the particle diameter with a bevel directing the particles towards the outlet orifice approximately equal to the particle diameter.

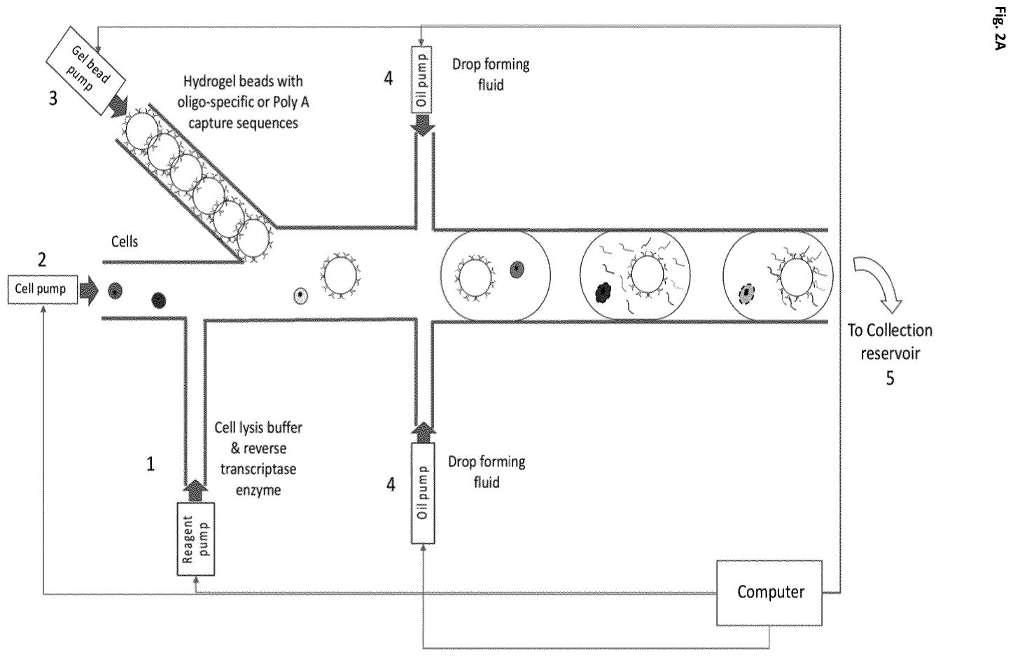

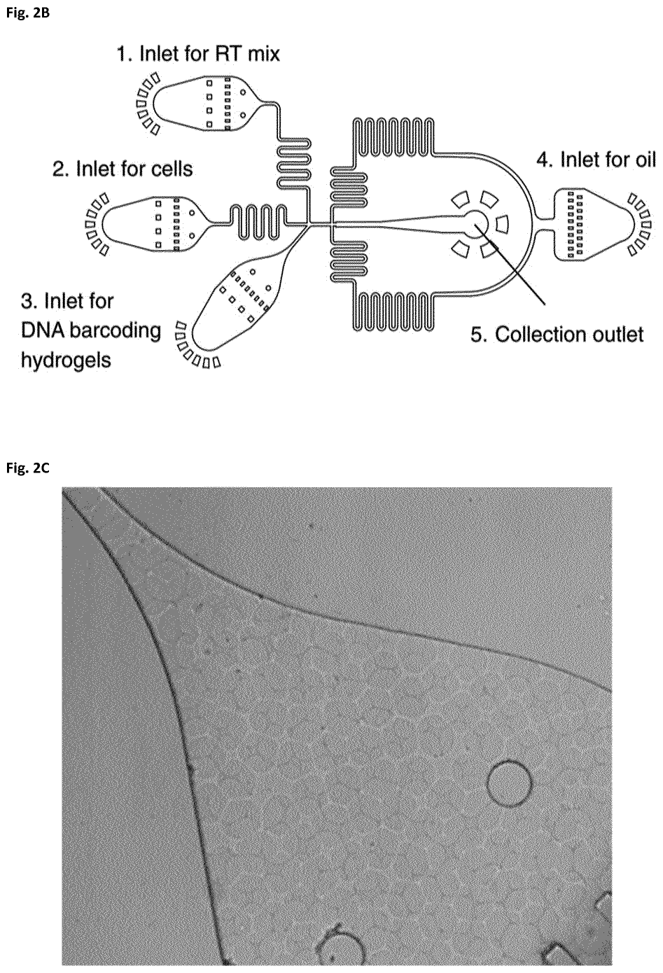

FIGS. 2A-D illustrate a method and application of the high efficiency encapsulation for genomic analysis of the nucleic acid (RNA or DNA) from a single cell in a drop in high throughput by analyzing the oligonucleotide labeled nucleic acid via sequencing.

FIG. 2A: Hydrogel beads with poly A or oligo-specific capture sequences containing unique barcode sequences are introduced into a drop forming region with cells, cell lysis buffer and reverse transcriptase enzyme. Drops are formed and the gel bead flow rate adjusted to have the rate of gel beads entering the drop forming junction equal the rate of drop formation. With this condition over 90% of the drops contain a hydrogel bead and cells are co-encapsulated with the hydrogel beads following a Poisson statistical distribution. The cells in each drop are lysed, the nucleic acid captured onto the bead and in the case of RNA captured on the bead, it is converted into cDNA containing a unique barcode specific to that cell.

FIG. 2B: Inlets are shown labelled 1 through 4, while the collection channel is number 5.

FIG. 2C: Fully packed beads ready for encapsulation. The beads show no gaps and are overlapped in a 3-dimensional close packed structure resulting in a high volume fraction of beads in the reservoir.

FIG. 2D: An example of a feedback loop for controlled introduction of gel beads into droplets to match the gel bead encapsulation rate to drop formation rate to achieve the >90% of drops with gel beads. Detected light signals related to the introduction of gel beads into the fluidic junction and formation of drops are inputs to a phase or frequency locked loop whose output is measured and processed by a computer to generate a feedback signal to control the pumps that drive liquids through each microfluidic channel, thereby synchronizes the rate of gel bead injection into the drop forming junction with the rate of drop formation.

FIG. 3A-B illustrates a method and application of the high efficiency encapsulation of gel bead particles for phenotypically analyzing the proteins, lipids, carbohydrates or nucleic acids from a single cell in high throughput in a drop by analyzing an optically labeled molecule from the cell via optical emission, absorption or scattering of light from the labeled molecule.

FIG. 3A: This schematic shows the mechanism by which a cell, fluorescently-labeled antibodies is and a hydrogel bead labeled with antibodies or antigen specific for capture of a secreted product from the co-encapsulated cell. The co-encapsulated cell could be a plasmablast secreting monoclonal antibody or an activated T cell secreting cytokines. The fluorescently-labeled antibodies bind to the secreted molecules wherein the fluorescent signal is localized onto the hydrogel bead if the capture reagent is specific to the secreted product and the magnitude of the fluorescence signal is proportional to the labeled molecules localized on bead surface or in the hydrogel structure. The fluorescent signal is created when the drop passes through a focused laser beam producing a time dependent optical signal that is detected by a photodetector and processed by a microprocessor.

FIG. 3B shows how the optical signal changes and dependency on the percentage of labeled molecules binding to the gel bead. If there is not binding, the labeled molecules remain freely floating and the optical signal originates from the volume of the drop. If there is binding between a captured molecule and the label, there is an optical signal that becomes localized onto the hydrogel bead and the optical signal from the drop correspondingly decreases in proportion to the increased signal originating from the gel bead.

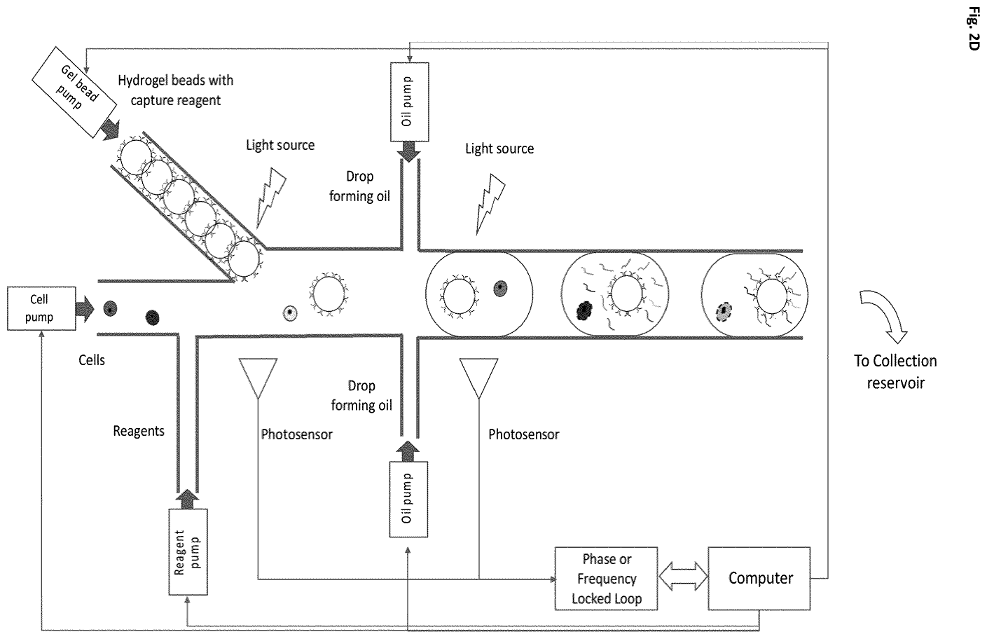

FIG. 4 illustrates a method and application of the high efficiency encapsulation for capture and analysis of a diversity of molecules on the gel bead surface including nucleic acids, proteins, lipids and polysaccharides from a lysed cell in high throughput in a drop by analyzing an optically labeled molecule from the cell via optical emission, absorption or scattering of light from the labeled molecule. Hydrogel beads with either oligo-specific capture sequences are introduced into a drop forming region with cells and oligo-specific fluorescent reagents and cell lysis buffer. These elements are co-encapsulated into a drop, the cell is lysed, the nucleic acids are released, captured onto the hydrogel bead and labeled with specific fluorophores corresponding to specific nucleic acid sequences. The drop passes through a focused laser beam and generates a nucleic acid sequence specific fluorescent emission which is detected and processed by a multi-color detection system. Optical signals at different wavelengths from the hydrogel bead are recorded and demultiplexed so that each signal can be enumerated independently and used to measure the presence of a specific fluorophore associated with the hydrogel bead.

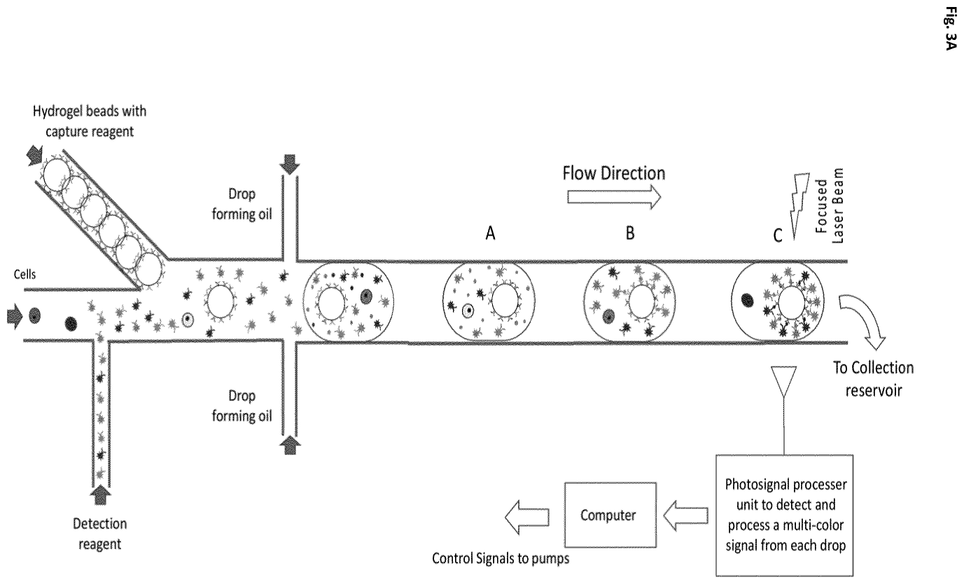

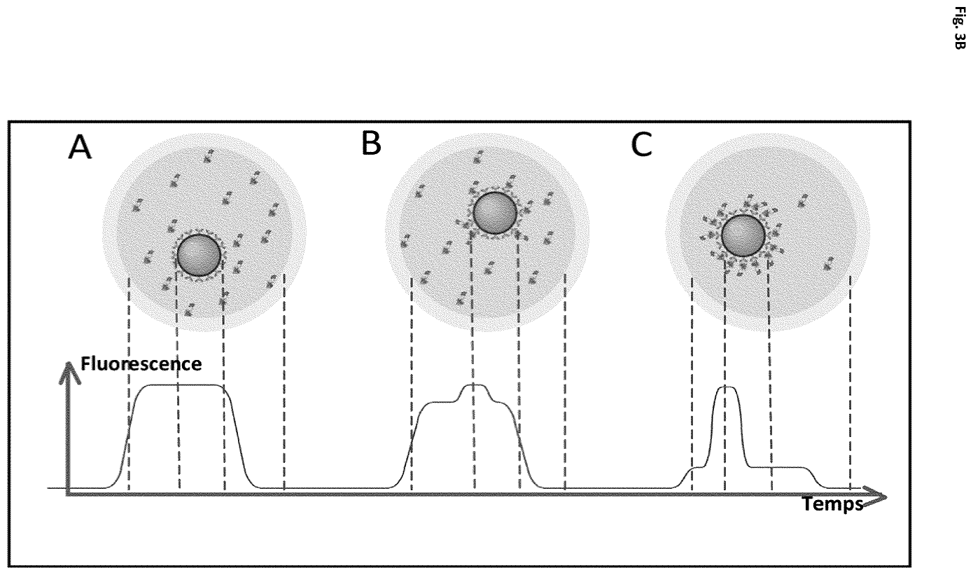

FIG. 5 illustrates a method and application of the high efficiency encapsulation for capture, analysis, and sorting of droplets including gel particles, cells, and a diversity of molecules. Shown is the preferred embodiment of the single gel bead—cell assay including a sorter device which diverts a drop into a different flow stream based on the photosignal detected by a photodetector and processed by a microprocessor to control the triggering of the sorter device to sort the drop.

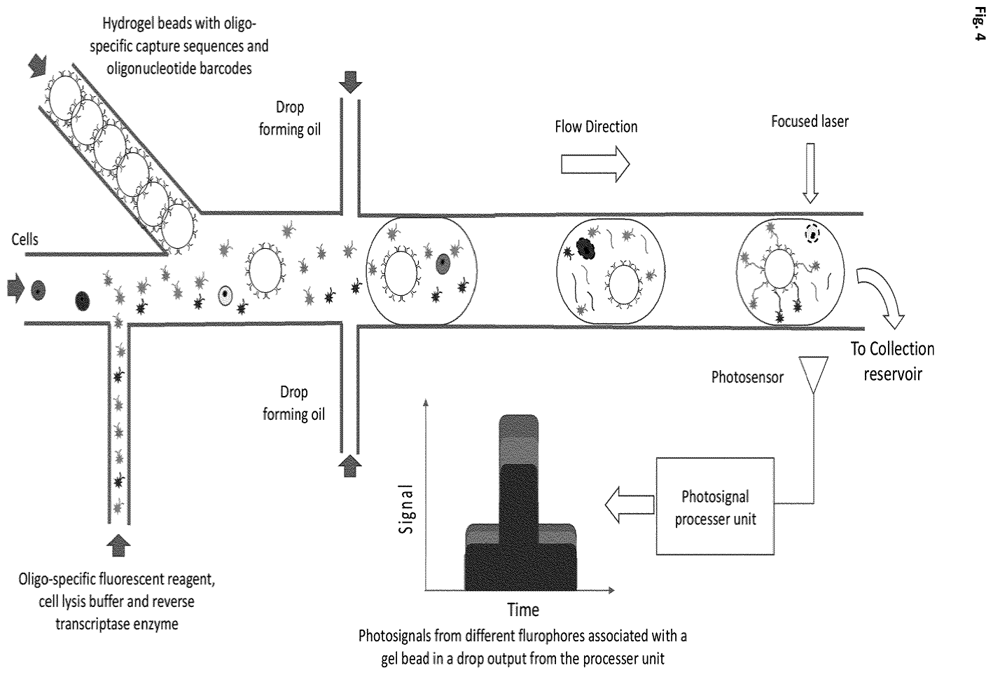

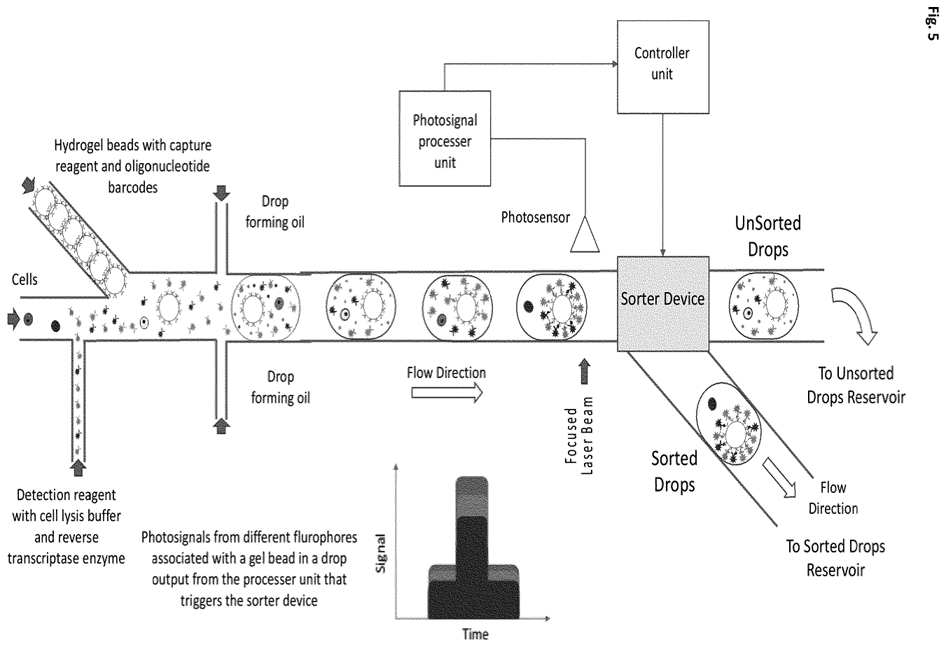

FIG. 6 illustrates a method and application of the high efficiency encapsulation for capture, analysis, and sorting of droplets including gel particles, cells, and a diversity of molecules. Shown is the preferred embodiment of the single gel bead—cell assay including a fusion device which fuses a drop containing a cell labeled with a fluorescently-labeled antibody with a drop containing an oligonucleotide-labeled gel bead, lysis buffer and reverse transcriptase enzyme. The fusion is triggered based on the photosignal detected by a photodetector and processed by a microprocessor to control the triggering of the fusion device to fuse the two drops.

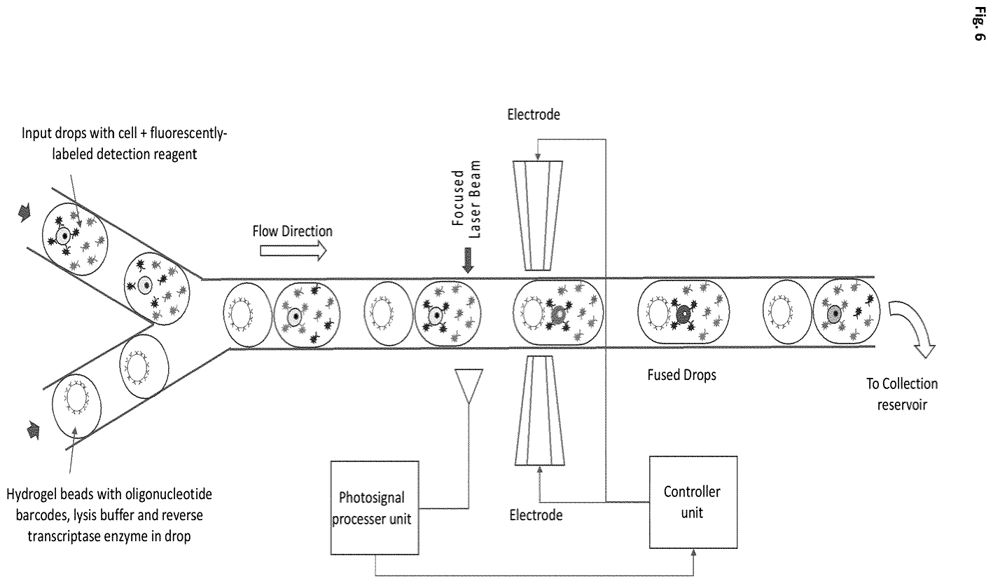

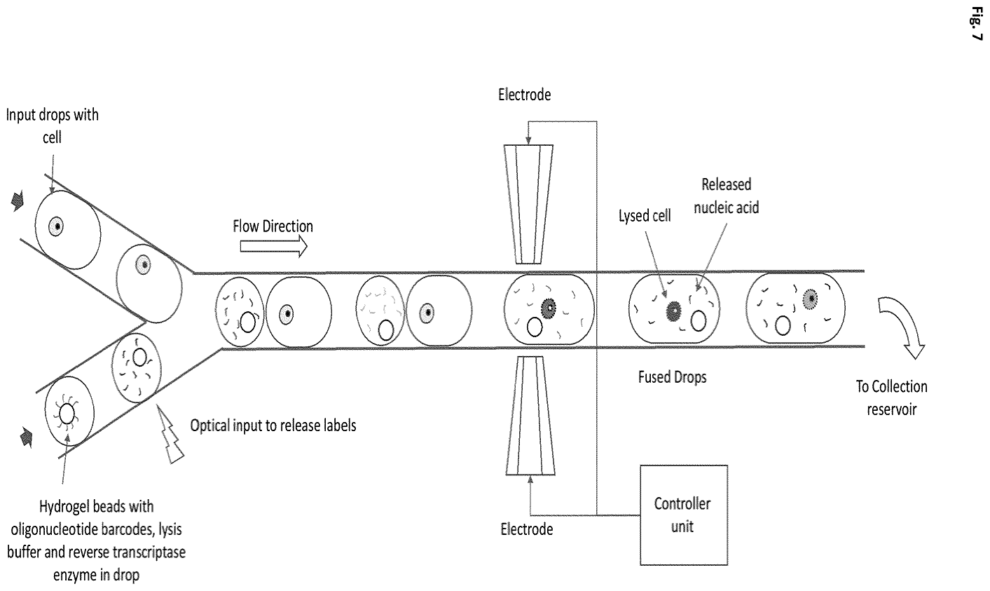

FIG. 7 illustrates a method and application to produce simultaneously droplets containing cells and hydrogel beads in aqueous solution into a dispersing phase, preferably oil, followed by a co-encapsulation of a droplet containing a cell and a droplet containing a hydrogel bead in oil into a dispersing phase, preferably aqueous. Shown is the preferred embodiment wherein one microfluidic device generates aqueous droplets in hydrophobic oil containing cells in a continuous flow stream and a second microfluidic device generates aqueous droplets in hydrophobic oil containing individual gel beads in a continuous flow stream. These streams are joined to together and two drops in hydrophobic oil are co-encapsulated in aqueous solution. A photosensor detects the contents of each droplet within the larger drop and a chemical stimulus or a pulsed electric field or acoustic surface wave is applied to fuse the two aqueous drops together to bring together the contents of each drop in a precise and reliable way.

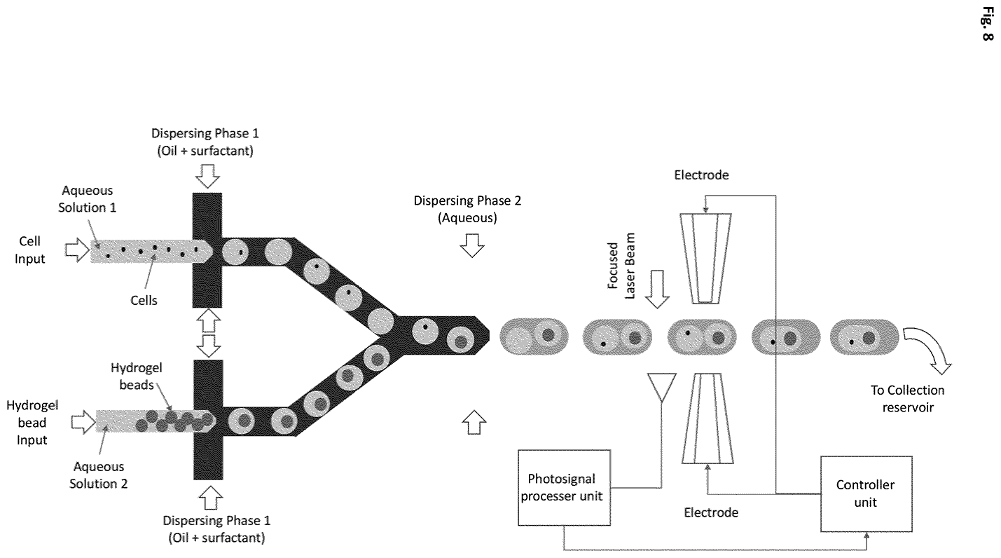

FIG. 8 illustrates a method and application to minimize the consumption of gel bead drops to be fused with sorted drops. Shown is a preferred embodiment wherein injection of gel beads in droplets into the flow stream of the sorted droplets is controlled and triggered by the sorting event. One droplet gel bead from a group of injected gel bead droplets is then fused with the sorted droplet.

### EXAMPLES

### Example 1

This example illustrates a microfluidic approach to high occupancy loading of polyacrylamide gel particles into microdroplets. FIGS. 1A and 1B show the top, end and side views of one preferred embodiment of the microchannel geometry and preferred dimensions relative to the particle diameter, D, to achieve the desirable 3D close packing configuration. FIG. 1C shows a microfluidic circuit wherein multiple microfluidic channels carrying Fluid A and Fluid B converge on a common fluidic chamber. A gel bead enters the chamber and downstream enters an orthogonal flow of hydrophobic oil that pinches off the fluids to form a drop. The fluidic chamber dimensions can be similar in height and width to a gel bead. Fluid A may contain cells in a dilute suspension, Fluid B may contain cell lysis buffer and reverse transcription enzyme and the gel particle may have attached oligonucleotide molecules as a unique barcode in one embodiment. The gel particles are close packed in three dimensions as evidenced by the overlap of gel particles in the microfluidic channel (FIG. 1D). The gel particles exit the microfluidic channel at a uniform frequency equal to the drop forming frequency resulting in the encapsulation of one particle in each drop formed. To achieve high occupancy of particles in drops, the flow rates for Fluid A and Fluid B are held fixed and the flow rate for the particles is varied so as to match the rate of particles entering into the drop forming junction with the rate of drop formation. The drop sizes (FIG. 1E) can be varied by increasing the flow rates of Fluid A, B and the drop forming oil. In turn the flow rate of the gel particles can be adjusted either manually or automatically using feedback control to match the frequency of drop formation and achieve a high occupancy rate of gel beads in drops, typically at rates exceeding 90% of drops with gel beads.

FIG. 1F shows an alternate embodiment wherein the microchannel exit is beveled into a nozzle to decrease the microchannel height to approximately equal the particle diameter. In this configuration the particles still exit the channel one at a time because of the 3D close packing and the bevel provides an additional layer of spatial selection on the particles exiting the microchannel to ensure high probability of obtaining one particle per drop. The second embodiment in FIG. 1G shows a similar concept except now the channel width is more than a particle diameter in width and is decreased in cross-section or beveled to decrease the channel width to direct the particles towards the outlet orifice but the height is still constrained to achieve the 3D close packing of the particles. The outlet orifice is approximately equal to the particle dimensions so as to allow only one particle at a time through the orifice.

### Example 2

This example illustrates an application of the high efficiency loading of gel particles into droplets for high throughput, high efficiency barcoding of nucleic acid (DNA, RNA) from single cells for a sequencing read-out. The process described in this example is for sequencing of barcoded RNA transcripts from single cells as outlined in FIG. 2A. Hydrogel beads with photolabile poly T or oligo-specific capture sequences containing unique barcode sequences are introduced into a drop forming region with cells, cell lysis buffer and a reverse transcriptase (RT) enzyme. Drops are formed that co-encapsulate a single cell, an oligonucleotide-labeled hydrogel bead, the cell lysis buffer and RT enzyme and the gel bead flow rate is adjusted to have the rate of gel beads entering the drop forming junction equal to the rate of drop formation. Introducing the cells as a dilute suspension into the drop forming junction results in the distribution of cells co-encapsulated in drops with hydrogel beads to follow a statistical Poisson distribution wherein over 90% of the drops can contain both a single cell and a single hydrogel bead.

The cells in each drop are lysed, the poly A sequence of the RNA transcript binds to the poly T sequence that, in turn, binds the cell transcripts to the bead. Alternatively, a gene specific primer replaces the poly T sequence in the gel bead-specific oligonucleotide barcode and this capture sequence hybridizes to its complementary sequence of the RNA released on cell lysis. Exposure to UV light releases barcode+RNA complex from the gel bead and heat activation of the RT enzyme converts the barcoded RNA molecule to a cDNA molecule labeled with a specific barcode sequence unique to the cell contained in the drop.

Achieving the high percentage of single cells co-encapsulated with a single bead indicates the cell suspension to be free of clumps, cell doublets. Minimizing barcode cross-talk between drops requires the gel bead preparation exposure to light to be minimized throughout the sample processing process. This means the preferred approach is to wash the gel beads with a low ionic strength buffer to remove any unattached barcode. Gel bead washing may remove chemicals (e.g. but not limited to ethylenediaminetetraacetic acid) that could impact RNA integrity and the efficiency of metal dependent enzymes such as reverse transcriptase.

The conditions for achieving a close packing of gel beads in the microfluidic channel prior to the drop forming junction starts with removal of the particle supernatant to form a gel pellet after centrifuging the gel beads that concentrates the particles. Washing in a high ionic strength, gel concentrating buffer reduces the gel particle diameter to a smaller diameter and the prepared gel particles are then loaded into the chip loading apparatus using an applied pressure differential between the microfluidic channel inlets and outlet. The time to achieve a close pack configuration of gel beads in the microfluidic channel is minimized when starting with a concentrated gel bead pellet where the fluid content is minimal and the gel bead concentration ^{˜}100%.

Inputs to the microfluidic device are (a) fluorinated oil containing 1%-10% surfactant; (b) RT/Lysis mix; and, (c) cells in dilute suspension (<100,000 cells/ml)) and the output collected in an external tube is an emulsion of droplets wherein each droplet contains a gel bead with a high concentration of RNA transcripts annealed to the barcode polyT sequence. The RT/lysis mix is prepared in advance at a higher starting concentration and diluted to a lower concentration prior to injection into the microfluidic device. A 30 μL of RT/Lysis mix per 1000 cells with an additional 40 μL for priming is prepared and, for example, if 10,000 cells are to be encapsulated and barcoded, then 340 μL of RT/lysis mix is prepared. Combine this mix on ice with 1.3× RT premix with MgCl₂, DTT, RNaseOUT, and SuperScript III (or another reverse transcriptase enzyme) and store this RT Lysis mixture in an Eppendorf tube on ice. For the cells, adjust the concentration of cells to be 100,000 cells/ml, or less, in 1×PBS containing 18 μL of the density-matching agent OptiPrep for every 100 μL of cell suspension. It is necessary to keep the RT/lysis mixture and cells at 4° C. during this preparation until injection into the microfluidic device.

The computer-controlled pressure pumps are driven by software to guide the fluidic priming of each channel of the microfluidic device to ensure there are no entrapped air bubbles in the microfluidic channels. Each fluid to be loaded into the microfluidic chip is aspirated into a small diameter, flexible tubing of known length and volume and primed to so there are no air bubbles by ensuring liquid completely fills the tubing. Once each tubing is fully primed, they are inserted into their respective ports on the microfluidic device (FIG. 2B) and the chip is fluidically primed by dispensing of fluid from each respective tubing. Each of these steps is under software control and the user is prompted and guided at each step of the priming, loading and encapsulation process by the software. Different from the other reagents and cells, there is an upper limit on the rate of aspiration of gel beads into the tubing prior to dispensing into the microfluidic chip since high flow rates (>2000 μl/hr) disrupts the close pack of the gel beads inside the tubing and typically 500 μl/hr is the range in which the gel bead packing in the tubing is most reliable. Dispensing of gel beads from the tubing into the microchip is a two-step process whereby the flow rate is first set at typically 100 μl/hr to rapidly fill the microfluidic channel with close packed gel beads. This flow rate is typically 2-3 fold higher than the flow rates for the other fluidic channels in order to have the gel beads quickly achieve a close packed configuration in the gel bead microfluidic channel. Once the close pack configuration is achieved, the flow is decreased typically to 50 μl/hr to have the rate of is bead encapsulation match the rate of drop formation.

As the gel particles enter the fluidic device, they pack in a 3D structure as shown in FIG. 2C. The gel particle flow rate may be adjusted to allow the formation of drops incorporating cells and RT/Lysis mixture and a single gel bead. Typical encapsulation gel particle encapsulation rates are 70-80% with the preset flow settings (50 μl/hr) and the gel particle flow rate can be adjusted manually to increase the gel particle encapsulation percentage to be >90%. This high gel particle encapsulation percentage translates into a high percentage of cells receiving a unique nucleic acid barcode sequence. A low encapsulation percentage (^{˜}<50%) of gel particles results in many cells that are not barcoded and this could be problematic if the cell number is limited, as can be the case with clinical specimens. Once the flow rates are established to achieve high occupancy of single gel particles in droplets is achieved, the cell-barcoded gel particle emulsion is collected in a 1.5 ml Eppendorf tube containing 200 μL of mineral oil and placed in a cooled collection block. The mineral oil and low temperature are necessary to prevent evaporation of the buffers comprising the drops and prevent droplet coalescence during the collection time. It is important to monitor encapsulation rates and adjust flow rates (recommended in 5-10 μL/h increments) during collection if necessary. There should be at most 1 gel particle in each droplet and about 90% of all droplets should contain gel particles. A small percentage, typically <1%, will have two or more gel particles per droplet. The gel bead occupancy can be determined by recording video sequence with a high-speed video camera imaging the microchannel outlet below the drop forming junction. To confirm the gel-bead:cell occupancy, a ^{˜}10 sec video sequence is recorded and the number of drops with gel beads and cells is counted. If the occupancy level is acceptable then the co-encapsulation process continues until all the cells are consumed. The emulsion is collected in an Eppendorf or similar collection and readied for the next processing step.

Release of the oligonucleotide barcodes from the gel beads requires exposure to UV light to cleave the light sensitive bond anchoring the barcodes to the gel bead. This step first requires the collection tube to be placed on ice and the emulsion exposed to UV light at 365 nm at an irradiance of 6.5 J/cm² for 10 minutes. Barcoded cDNA is synthesized by heating the tube to 50° C. for 2 hours to activate the RT enzyme and allow cDNA synthesis to occur. The reaction is terminated by heating for 15 min at 70° C. The tube is cooled and the mineral oil and residual droplet-making oil removed with a pipette. If necessary, the emulsion is divided into fractions containing the desired number of cells. For example, if 4000 cells were barcoded, the entire emulsion volume is divided in two equal parts to get 2×2000-cell libraries. The emulsion is dissolved by adding 1 volume of surfactant such as, perfluorooctanol, in a concentration of 10%-100%, to each tube. The cDNA is in the aqueous phase and is now ready to undergo the next step of processing to prepare libraries for next generation sequencing on a commercially available sequencing machine. At this point, the tubes can be stored at −80° C. for at least 3 months, or sequencing libraries can be prepared from the samples immediately.

The same protocol for encapsulation of cell can be used for encapsulation of other biological microparticles and nanoparticles such as, but not limited to, bacteria, fungi, spores, exosomes, nuclei, and viruses. To encapsulate other biological particles, ensure the sample has few clumps of particles and is free of lysate or debris. It is also important to ensure high viability under the reaction conditions. The viability of the sample should be above 95% and remain above 90% after 30 minutes on ice. It is important the concentration of biological particles be in a dilute suspension at approximately 100,000 particles/ml and a density matching reagent to make a homogeneous suspension. This ensures Poisson statistical loading of the bioparticles to minimize the likelihood of more than one particle being encapsulated in each drop.

### Example 3

This example describes a feedback control system for synchronizing the rate at which gel beads are injected or introduced into the drop forming junction with the rate of droplet formation. In reference to FIG. 2D, a first light source is positioned to illuminate the drop forming junction with a first photosensor to detect the light scattered, absorbed or emitted from the gel beads as they exit the microfluidic channel into the drop forming junction. A second light source is positioned to illuminate the drop formation region with a second photosensor to detect the light scattered, absorbed or emitted from the drops as they exit the drop formation region. The two photosensor signals are input to a phase or frequency locked loop that measures and outputs a third signal related to the phase or frequency difference between the two periodic input signals. This output signal is recorded by a computer and algorithmically processed to produce a control signal used for feedback control of the fluidic pumps driving the flow of liquid in each microfluidic channel, including the gel bead channel, so as to synchronize the rate by which gel beads are introduced into the drop forming junction with the rate of drop formation.

### Example 4

This example illustrates the application of high efficiency loading of gel particles into droplets to implement a high throughput single cell assay. In the particular example shown in FIG. 3A, is attached to the hydrogel bead is a molecule for non-specific capture of a target molecule secreted by the cell. This could be for example a cytokine secreted by an activated T cell. Alternatively, the molecule attached to the hydrogel bead be could for specific capture of the target molecule secreted by the cell and in this instance the capture molecule is an antigen and the secreted molecule is, for example, an antibody secreted by a plasmablast B cell in the drop. In each case a unique oligonucleotide barcode sequence is associated with each hydrogel bead so as to provide a unique label to the target molecule for cell-specific identification and assignment during any post-drop processing and analysis step. A second optically active reagent that binds to the target molecule is co-encapsulated in the drop with the cell and modified hydrogel bead. The secondary reagent could be, for example, an antibody to which a fluorescent, absorptive, Raman-active or phosphorescent molecule or a fluorescent quantum dot is attached. The secondary reagent binds to the target molecule and if there is a binding interaction between the target molecule and the capture molecule on the hydrogel bead, then the target and secondary molecule will become attached to or localized to the hydrogel bead and the relative magnitude of the associated optical signal will vary in proportion to the number of target-secondary molecules captured by the bead (FIG. 3B). The optical signal is generated by a focused laser beam and the optical signal detected and processed by a photosensor and processer unit.

As diagrammed in FIG. 3B, if there is no interaction between the secreted molecules and labeled bead, there is no fluorescent signal spatially associated with the gel bead and only a diffuse fluorescent signal distributed within the drop volume is detected as the drop passes through the laser beam focused into the flow stream. If some of the secreted molecules interact with the molecular labels then the localized fluorescent signal increases relative to the diffuse, drop-wide background and if all of the molecules interact with the molecularly-labeled gel bead then the localized fluorescent signal is a maximum. The number of optical labels in the drop is large yet finite in number and as the number of optical labels become specifically associated with the gel bead, the number of labels free in solution in the drop decreases in proportion to the number of labels associated with the gel bead and the optical signal from the bead is increased while the background signal from the drop decreases. Based on the magnitude of the fluorescent signal detected, that particular drop can be removed or sorted from the flow stream with a variety of different methods including exposing a specific droplet to the action of an applied energy field (e.g. electric, acoustic, mechanical) to move the drop from the flow stream to a secondary flow channel where these sorted or selected drops can be further analyzed. Multiple different capture probes can be immobilized in the gel bead either during synthesis, coupled to the gel polymer directly or coupled is to the gel polymer via an intermediate molecule such as streptavidin. A collection of multiple different molecular species from a single cell from a collection of cells at high throughput can be captured and analyzed by this method. Similarly, a number of different optical labels can be introduced into the drop to specifically label each molecular species either captured onto the gel bead or as a membrane protein of one or more cells co-encapsulated with the gel bead in the drop.

One specific advantage of the gel bead in the implementation of this assay is the high co-encapsulation rate that allows efficient analysis of a large population of cells and is of particular importance when identifying and selecting for removal rare or low frequency cells in a population for further analysis. Another specific advantage of the gel beads is the high dynamic range and sensitivity for optical detection related to the high surface area to volume ratio of the gel beads that enables capture and detection of small numbers of molecules secreted from a cell. The high porosity of the gel bead relative to other highly cross-linked polymer beads means there is an increased surface area for attachment of capture probes and therefore a larger surface area and capacity for capture and immobilization of target molecules. The larger volumetric surface area enabled by the gel bead means more capture probes can be localized with a gel bead compared to a hard particle or surface. This in turn means more analytes can be captured and detected in less time in contract to hard polymer beads where only the surface area is available for capture of target molecules. By way of illustration, the ratio of surface area to volume for a spherical particle is 6/D where D is the particle diameter so a 60 micrometer porous gel particle with 1% porosity could have a capture volume 1,000 fold larger than a solid polymer sphere of the same diameter. This larger capacity can result in the capability to detect low amounts of analyte in the drop and over a larger dynamic range, thus resulting in improved single cell assay performance. The close proximity of capture probes to one another three dimensionally in the gel matrix allows for captured probes which are released stochastically depending on their affinity, to be recaptured by neighboring probes, further increasing the sensitivity to a small number of molecules or low affinity interactions as compared to probes on a hard surface. The proximity of molecules in the porous matrix also opens the possibility of implementing sensitive optical assays based on proximity of a fluorescence and quencher molecule such as the Forster Resonance Energy Transfer (FRET) fluorescent assays. Another advantage of the hydrogel beads for single cell assays in drops is the ability to vary the hydrogel porosity to increase (or decrease) the bead binding capacity and vary the range of sensitivity and dynamic range of molecules detected by binding or co-localizing to the hydrogel bead. A fourth advantage is the enablement of a general strategy for modifying hydrogel beads to be a single cell assay detection reagent. In this particular example, streptavidin or avidin is is incorporated into the hydrogel polymer and is used to immobilize in the polymer various biotinylated molecules to be used in a single cell assay. As a specific instance, biotinylated antibodies specific for the capture of cytokines secreted by the cell could be incorporated into the hydrogel bead and used to measure cytokines generated by the co-encapsulate cell in the drop. Other molecules such as antibodies could be similarly incorporated into the gel matrix for capture of specific antigens such as cytokines or other small molecules.

### Example 5

In this example, specific molecules from the cellular content of an encapsulated cell can be captured and analyzed with a modification of the gel bead and detection reagents and the inclusion of a lysis buffer in the drop. As shown in FIG. 4, attached to the gel beads is a capture reagent with a unique oligonucleotide barcode sequence for capture and immobilization of one of several types of molecules on the gel bead including nucleic acids, proteins, lipids and polysaccharides. For example, a capture reagent could be a specific oligonucleotide sequence complementary to a nucleic acid sequence in a cell or the capture reagent could be Protein A or Protein G to capture and immobilize proteins from the cell in the gel bead.

A cell is combined with a labeled bead, detection reagents and a lysis buffer in a single drop. Loading of these reagents with the gel bead in the drop is implemented by 3D close packing of the gel beads in the microfluidic channel to ensure the gel bead occupancy in the drops is >90%. The cells are introduced in a dilute suspension and they are distributed according to a Poisson distribution through the drops. Finally, the cell lysis buffer, typically a low concentration surfactant like Triton X™, is combined with the detection reagent and injected into the microfluidic device through a separate microfluidic flow stream.

Once encapsulated in a drop, the cell is lysed and its molecular content released into the drop. Depending on the affinity of the capture reagent for the particular molecular species present in the drop, only a fraction of the available molecules may be captured onto or into the gel bead. An approach similar to the one described in Example 2 detects the localized fluorescent signal from the capture and fluorescent labeling of the molecular species from within the cell onto the gel beads. In this example the capture reagent is one or more oligonucleotide sequences complementary to one or more specific sequences in the nucleic acid from the cell. Incubation of the drops post-lysis of the cells provides the conditions for hybridization of those nucleic acid sequences to the complementary sequences immobilized in the hydrogel bead. Each immobilized sequence can be detected by hybridization of a fluorescently-labeled short oligonucleotide sequence complementary to the immobilized sequence wherein each detection sequence has associated with it a different fluorescent probe, thus enabling a multi-color read-out by detection of the multiple wavelength optical signal stimulated as the labeled hydrogel bead passes through the focused laser beam and the detected signals are wavelength-demultiplexed and further processed to identify and enumerate the nucleic acid sequences isolated from each single cell. Furthermore, the presence of a unique cell-specific barcode sequence allows for a sequence-based read out to further analyzed the nucleic acid sequences captured onto the hydrogel bead.

### Example 6

This example illustrates a continuation of Example 4 or Example 5 wherein the high efficiency loading of gel particles labeled with unique barcode oligonucleotide sequences and, optionally, specific capture reagents into droplets is applied to implement a high throughput single cell assay followed by a selective sorting from the flow stream of drops showing a positive signal relative to the specific assay implemented in the drop. Alternatively, the photosignal to trigger the sorter unit to selectively remove a drop from the flow stream could be derived from a specifically labeled cell in the selected drop. The process as described in Example 4 or Example 5 is followed with the microfluidic device as described but modified to include a sorting element that applies an electric field or acoustic wave at the appropriate time to deflect the drop from one channel into a second channel fluidically connected to the first channel.

The advantage of the ability to select, sort and collect specific drops from a flow stream in combination with the ability to insert into a high percentage of drops a labeled gel particle and perform an assay with the gel particle in the drop is multi-fold. First, it allows for the selection and separation of a specific subset of cells from a larger collection or population of cells based on a specific functional phenotype based on a measured parameter such as a specific molecule secreted by the cell or a specific molecule or set of molecules expressed and presented on the cell membrane. Second, it enables the detection of rare cell types such as circulating tumor cells or cancer stem cells in a population of cells based on different phenotypic properties and the ability to analyze and sort large numbers of cells quickly (ca 1000 cells/s). Third, it enables the assay of fragile cells such as neurons that are not readily adaptable to conventional flow-based assay analyses and to sort these cells based on a phenotypic presentation. The cells in the sorted drops are then lysed and the genomic and/or proteomic content analyzed in a manner similar to the process described in Example 2 such that the information provided by the assay read-out is linked to the genomic and/or proteomic profile of a single cell. In this way the phenotype and genomic and/or proteomic profile of single cells selected from a larger population of cells can be determined.

FIG. 5 shows one preferred embodiment of the process based on Example 4. The flow system and droplet assay as described in Example 4 is implemented with the addition of the drop sorter unit under feedback control by a single or multicolor photosignal detection and processing unit. A detected positive signal triggers the sorter to energize and apply either a pulsed electric or acoustic field that applies a momentary force to the drop to re-direct the drop to a second, fluidically connected channel that is connected to a chamber to collect the sorted drops. The drops that do not trigger the sorting signal continue without interruption and are collected in a different container.

Similarly, a second preferred embodiment starts with the description in Example 5 with the addition of the drop sorter unit under feedback control by a single or multicolor photosignal detection and processing unit. A detected positive signal triggers the sorter to energize and apply either a pulsed electric or acoustic field that applies a momentary force to the drop to re-direct the drop to a second, fluidically connected channel that is connected to a chamber to collect the sorted drops. The drops that do not trigger the sorting signal continue without interruption and are collected in a different container.

The gel bead is labeled with a unique oligonucleotide barcode, then in both examples the nucleic acids or proteins from the sorted drops are specifically labeled for further processing and sequencing to reveal genotypic and/or proteomic information on the selected sorted cells.

### Example 7

This example illustrates a continuation of Example 4 or Example 5 wherein the high efficiency loading of gel particles into droplets is utilized to implement a high throughput single cell assay followed by a selective fusing of gel particles in drops with drops in a flow stream showing a positive signal relative to the specific assay implemented in the drop or labeling of a cell in the drop. The process as described in Example 4 or Example 5 is followed with the microfluidic device as described but modified to include a fusing element that applies an electric field or acoustic wave or chemical stimulus at the appropriate time and position in the flow stream to fuse the drop containing a gel bead with the drop containing the cell to combine the two drops into a single larger drop.

The advantage of the ability to select, fuse and collect specific drops from a flow stream in combination with the ability to insert into a high percentage of drops a labeled gel particle and perform an assay with the gel particle in the drop is multi-fold. First, it allows for the selection and separation of a specific subset of cells from a larger collection or population of cells based on a specific functional phenotype based on a measured parameter such as a specific molecule secreted by the cell or a specific molecule or set of molecules expressed and presented on the cell membrane. Second, it enables the detection of rare cell types such as circulating tumor cells or cancer stem cells in a population of cells based on different phenotypic properties and the ability to analyze and sort large numbers of cells quickly (ca 1000 cells/s). Third, it enables the assay of fragile cells such as neurons that are not readily adaptable to conventional flow-based assay analyses and to sort these cells based on a phenotypic presentation.

This Example 7 describes an alternative to Example 6 wherein a drop is selectively re-directed from the microfluidic flow stream based on an assay signal for further processing such as single cell barcode sequencing as described in Example 2. In the present example, the assay signal is used to trigger a fusion event that combines the drop containing the cell and assay components with an adjacent second drop containing an oligonucleotide barcode-labeled hydrogel bead and other reagents to lyse the cell and implement the process of barcoding the nucleic acid of the lysed cell for subsequent sequencing.

FIG. 6 shows one preferred embodiment of the process based on Example 4. The flow system and droplet assay as described in Example 4 is implemented with a junction that brings together in proximity a drop containing a gel bead with a drop containing a cell. The two adjacent drops encounter a drop fusing unit under feedback control by the single or multicolor photosignal detection and processing unit. A detected positive signal from the cell containing drop triggers the fusing unit to energize and apply either a chemical stimulus, a pulsed electric or acoustic field to the two adjacent drops to fuse them into a single, larger volume drop. The drops that do not trigger the sorting signal continue without interruption into a collection reservoir. It is only the nucleic acid from the cells in the fused drops that is barcoded and subsequently sequenced and therefore is an alternative to physical sorting of the drops. This approach enables linking the cell phenotype as determined by the bioassay or label with the cell genomic profile on a cell by cell basis across a group of cells selected by the bioassay read out from a larger population of cells.

Similarly, a second preferred embodiment starts with the description in Example 5 with a junction that brings together in proximity a drop containing a gel bead with a drop containing a cell. The two adjacent drops encounter a drop fusing unit under feedback control by the multicolor photosignal detection and processing unit. A detected positive signal from the cell containing drop triggers the fusing unit to energize and apply either a pulsed electric or acoustic field to the two adjacent drops to fuse them to make a single, larger volume drop. The drops that do not trigger the sorting signal continue without interruption into a collection reservoir. As in the first example, it is only the nucleic acid from the cells in the fused drops that is barcoded and subsequently sequenced to determine the genomic profile of the selected cells. This approach enables linking the cell phenotype as determined by the bioassay or label with the cell genomic profile on a cell by cell basis across a group of cells selected by the bioassay read out from a larger population of cells.

A third preferred embodiment is described in FIG. 7 where the ability to load barcode labeled hydrogel beads singly at high efficiency into drops and the ability to fuse adjacent drops is used as an alternative approach in the implementation of the process for barcoding nucleic acids from single cells described in Example 2. In this embodiment the hydrogel beads, lysis buffer and reverse transcriptase enzyme are loaded into one set of drops and the cells are loaded into a second set of drops and the two sets of drops are brought together serially into a common channel where a drop containing a hydrogel bead is adjacent and in contact with a drop containing a cell. Prior to entering the common microfluidic channel the drops containing the hydrogel beads is exposed to a pulse of UV radiation so as to release into solution the photolabile olignonucleotide barcode sequences attached to the hydrogel bead. The oligonucleotide barcodes in solution are free to interact and hybridize to the RNA released from the lysed cell when a hydrogel bead drop is merged with a drop containing a cell. As a hydrogel bead containing drop that is adjacent to a cell containing drop moves through the common channel, it enters a region defined by a pair of spatially opposing electrodes that when energized with an electrical high voltage pulse results in the fusion of the two drops. In the fused drop the cell is lysed, releasing the RNA which then hybridizes with the barcode olignonucleotide in solution. A population of drops is then collected and the temperature raised to activate the reverse transcriptase to generate barcoded cDNA which is subsequently further processed to generate a library for sequencing on a commercially available sequencer instrument.

### Example 8

This example illustrates an example similar to Example 7, however this method produces simultaneously droplets containing cells and hydrogel beads in aqueous solution into a dispersing phase, preferably oil, followed by a co-encapsulation of a droplet containing a cell and a droplet containing a hydrogel bead in oil into a dispersing phase, preferably aqueous. A fluorescence-based detection system allows to selectively fuse droplets containing cells of interest by a chemical stimulus, an electric field or an acoustic wave into a larger droplet.

The advantages are multiple, including, but not restricted to the ones listed in Example 7. First, the water-oil-water emulsion ensure that cross-contamination of cDNA or small molecules is minimized as there is an additional layer which acts as a diffusion barrier. Second, spontaneous coalescence of droplets containing cells, and therefore cross-contaminating results is further limited by the oil phase of the droplet which separates them from other oil droplets containing aqueous droplets. Third, the oil used in these experiments can be used as a gas reservoir or drain for the aqueous droplets inside them through which for example oxygen can easily diffuse in or out into the aqueous droplets, affecting the transcriptome of oxygen sensitive cells for example.

FIG. 8 shows one preferred embodiment of the process in Example 3. The flow system as described in Example 4 is implemented in parallel to a flow-focusing droplet generator which encapsulates cells which have been either pre-labelled or which are labelled in the droplet. These two droplets are made by a dispersing phase of fluorinated oil, e.g. HFE-7500 and a surfactant. The two droplets are paired up and further encapsulated into an oil in water emulsion. In analogy to Example 7, the droplets pass an optical multi-spectral detection unit which is connected to a real-time processing unit allowing to fuse selectively droplets either by an electric field or an acoustic wave. As droplets are only selectively fused, only the nucleic acid from cells in droplets which were fused will be barcoded and subsequently amplified to reveal the genetic information of the sample.

### Example 9

This example illustrates an example similar to Example 6, however it is directed towards minimizing the consumption of gel beads fused with the drops sorted by the sorting device. In one embodiment, gel beads in drops are in a microchannel fluidically connected to the same microfluidic channel that is the output from the sorter device. When a drop is selected from the primary flow stream by the sorter unit, the microfluidic channel containing the gel bead encapsulated drops is pressurized for a pre-determined amount of time to inject multiple gel bead encapsulated drops into the same fluidic channel as the sorted drop. These drops are then introduced to the fusion section and at least one gel bead is fused with the sorted drop. After the specified time has elapsed, the channel pressure is reduced to zero so no gel bead drops are injected into the sorter channel. In this way the number of gel beads is minimally consumed. Another embodiment is to have a valve between the gel bead and sorter drop channels that opens and closes to inject a prescribed number of gel bead drops into the mic. In this way many cells can be sorted and sequenced without consuming an excess of beads.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other is elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the invention includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method of ordering, sorting and/or focusing particles, the method comprising leading the particles through a microfluidic channel comprising a channel height (H) in the range of 1.8 D to 1.2 D, wherein D is the particle diameter.

2. The method of claim 1, wherein the microfluidic channel comprises a channel width (W) in the range of 1.33 D to 1 D.

3. The method of claim 1, wherein the microfluidic channel comprises a chamber for a particle reservoir, wherein the chamber height requires 1.2 to 1.8 times the particle diameter and the chamber width is at least greater than twice the particle diameter.

4. The method of claim 1, wherein the particles are packed in the chamber before entering the microfluidic channel.

5. The method of claim 3, wherein the chamber comprises tapered lines leading to the microchannel.

6. The method of claim 1, wherein the microfluidic channel height is decreased at the exit.

7. The method of claim 1, wherein the inner wall of the microfluidic channel is hydrophobic.

8. The method of claim 1, wherein the particles are composed of a polymer material with an elastic modulus.

9. The method of claim 1, wherein the particles are hydrogel beads.

10. The method of claim 1, wherein the particles comprise capture molecules.

11. The method of claim 10 wherein the capture molecules may be selected from the group comprising, an antigen, an antibody or fragments thereof, nucleic acids, magnetic particles, colloidal particles, nanoparticles, quantum dots, small molecules, proteins, indicators, dyes, fluorescent species and chemicals.

12. The method of claim 1, wherein the particles enter a downstream T junction into which hydrophobic oil flows and a droplet is formed by the hydrophobic oil when this oil is momentarily interrupted when the particle blocks the flow of oil and the oil fills behind the particle as it passes through the junction.

13. The method of claim 1, wherein a drop sorter unit under feedback control of a photosignal detection and processing unit and a further microfluidic channel is provided, wherein a detected positive signal triggers the sorter to energize and apply a pulsed electric or acoustic field to the droplet to redirect the droplet into the further microfluidic channel.

14. The method of claim 1, wherein a drop fusing unit under a feedback control and at least one further microfluidic channel is provided, wherein differently loaded drops are leaded through both channels which are connected via a junction, wherein the feedback control is activated by one of the drops and triggers the fusing unit to energize and apply either a pulsed electric or acoustic field to the two differently loaded drops to fuse them to a single larger volume drop.

15. The method of claim 1, comprising
encapsulating a set of cells in aqueous droplets in a hydrophobic oil in a flow stream in a first microfluidic system comprising at least one microfluidic channel and a T-junction:
encapsulating a set of gel beads in aqueous droplets in a hydrophobic oil in a flow stream in a second microfluidic system comprising at least one microfluidic channel and a T-junction;
combining the two flow streams by leading them through the microfluidic channels of the first and the second system which are connected via a junction; and
co-encapsulating at least two drops from each flow stream in the same drop defined by the two aqueous drops in hydrophobic oil surrounding by an aqueous phase and applying a pulsed electric or acoustic field to merge the two aqueous drops inside the oil drop together.

16. A microfluidic channel system comprising at least one microfluidic channel wherein the channel height (H) is in the range of 1.8 D to 1.2 D and the channel width (W) is in the range of 1.33 D to 1 D, wherein D is the particle diameter.

17. (canceled)

18. A method of ordering, sorting and/or focusing particles, the method comprising leading the particles through a microfluidic channel comprising an inner cross section which can be rectangular or elliptic and which size is defined by a major and a minor orthogonal axe, wherein the major orthogonal axe is in the range of 1.8 D to 1.2 D and the minor diagonal axe is in the range of 1.33 D to 1 D wherein D is the particle diameter.
